(19) United States
(12) Patent Application Publication
(10) Pub. No.: US 2019/0279265 A1
(43) Pub. Date: Sep. 12, 2019

(54) ONLINE DEAL MAKING PLATFORM

(71) Applicant: DealigentRx, West Palm Beach, FL (US)

(72) Inventor: Eugene Lee Kim, West Palm Beach, FL (US)

(73) Assignee: Dealigent LLC, DBA DealigentRX, West Palm Beach, FL (US)

(21) Appl. No.: 16/294,321

(22) Filed: Mar. 6, 2019

Related U.S. Application Data
(60) Provisional application No. 62/639,491, filed on Mar. 6, 2018.

(51) Int. Cl. G06Q 30/06

(52) U.S. Cl. CPC G06Q 30/0609; G06Q 50/18

(57) ABSTRACT

An online deal making platform allows direct party-to-party asset transactions. The online deal making platform provides prepackaged due diligence prior to entering into an agreement between the parties. The prepackaged due diligence includes a questionnaire about an asset that is presented to and answered by a seller of the asset. The questionnaire is designed to identify material issues upfront.

### CROSS-REFERENCE TO RELATED APPLICATION(S)

This application claims priority to U.S. Application No. 62/639,491, filed on Mar. 6, 2018, titled ONLINE DEAL MAKING PLATFORM, the disclosure of which is hereby incorporated by reference in its entirety.

### BACKGROUND

Asset transactions often require buyers and sellers to engage in complex due diligence processes to thoroughly assess the asset. Only after a thorough due diligence process has been conducted can the buyer feel comfortable in proceeding with the transaction. But the due diligence process requires both parties to invest a lot of time and energy and incur significant expense. Even so, in many cases important issues are still not identified until late into the due diligence process.

### SUMMARY

In general terms, the present disclosure is directed to an online deal making platform. In one possible configuration and by non-limiting example, the online deal making platform provides prepackaged due diligence before entering into a deal between parties. Various aspects are described in this disclosure, which include, but are not limited to, the following aspects.

One aspect is an online deal making platform for facilitating transactions between businesses, the platform comprising: at least one processing device; and at least one computer readable storage device storing instructions that, when executed by the at least one processing device, cause the at least one processing device to: transmit data instructions to a seller user's computing device, the data instructions being executable by the seller user's computing device to generate prepackaged due diligence for an asset, the data instructions being executable to: prompt the user to answer questions about the asset; receive answers to the questions, the answers including confidential information; and process the answers to generate a summary of the asset including at least one asset score, wherein the at least one asset score is based at least in part on the confidential information but does not contain the confidential information; transmit the summary of the asset to the online deal making platform; and store the answers to the questions for transmission to a data room without transmitting the answers to the online deal making platform; generate an asset listing including the summary of the asset; present the asset listing to a buyer user; receive a request from the buyer user to obtain additional information about the asset; direct the buyer user to the data room to obtain additional information about the asset; receive an intent to enter into a deal for the asset from a buyer user; and notify the seller user of the buyer's intent to enter into a deal for the asset.

Another aspect is an online deal making platform for transactions, the system comprising: at least one processing device; and at least one computer readable storage device storing instructions that, when executed by the at least one processing device, cause the at least one processing device to: receive descriptions of assets from seller users of the online marketplace; evaluate the assets based on the descriptions; generate a plurality of listings associated with the assets, each of the listings including the evaluation of a corresponding asset; present the plurality of listings to buyer users; receive a request for a transaction of at least one of the plurality of listings from at least one of the buyer users; and notify at least one of the seller users associated with the at least one of the plurality of listings that the request of a transaction is received from the at least one of the buyer users.

A further aspect is a method for facilitating transactions, the method comprising: transmit data instructions to a seller user's computing device, the data instructions being executable by the seller user's computing device to generate prepackaged due diligence for an asset, the data instructions being executable to: prompt the user to answer questions about the asset; receive answers to the questions, the answers including confidential information; and process the answers to generate a summary of the asset including at least one asset score, wherein the at least one asset score is based at least in part on the confidential information but does not contain the confidential information; transmit the summary of the asset to the online deal making platform; and store the answers to the questions for transmission to a data room without transmitting the answers to the online deal making platform; generate an asset listing including the summary of the asset; present the asset listing to a buyer user; receive a request from the buyer user to obtain additional information about the asset; direct the buyer user to the data room to obtain additional information about the asset; receive an intent to enter into a deal for the asset from a buyer user; and notify the seller user of the buyer's intent to enter into a deal for the asset.

Yet another aspect is a database server for managing confidential asset data for online transactions, the database server comprising: at least one processing device; and at least one computer readable storage device storing instructions that, when executed by the at least one processing device, cause the at least one processing device to generate an online marketplace to: receive encrypted data of confidential information from seller computing devices, the confidential information including at least one seller's answer to a due diligence questionnaire about an asset; store the encrypted data; receive a request for additional information about the asset from a user computing device; and transmit at least part of the encrypted data to the user computing device.

### BRIEF DESCRIPTION OF THE DRAWINGS

FIG. 1 illustrates a system for online transaction in accordance with an exemplary embodiment of the present disclosure.

FIG. 2 illustrates an exemplary architecture of a computing device that can be used to implement aspects of the present disclosure.

FIG. 3 is a flowchart of an example method for operating the system of FIG. 1.

FIG. 4 is a block diagram of an example architecture of an online deal making engine of FIG. 1.

FIG. 5 is a flowchart of an example method of performing an asset due diligence engine included in the online deal making platform.

FIG. 6 is a block diagram of example contents of an asset summary.

FIG. 7 is a flowchart of an example method for obtaining an asset score associated with an asset.

FIG. 8 illustrates an example list of questions with possible answers and scores assigned to the answers.

FIG. 9 is a flowchart of an example method for storing information of the asset.

FIG. 10 is a flowchart of an example method for generating an asset listing.

FIG. 11 is a flowchart of an example method for requesting additional information about the asset.

FIG. 12 is a flowchart of an example method for facilitate a deal for the asset.

FIG. 13 illustrates an example layout of a user registration page of a user interface.

FIG. 14 illustrates an example layout of a dashboard page of the user interface.

FIG. 15 illustrates an example layout of a prepackaged due diligence page of the user interface.

FIG. 16 illustrates another example layout of the prepackaged due diligence page.

FIG. 17 illustrates another example layout of the prepackaged due diligence page.

FIG. 18 illustrates yet another example layout of the prepackaged due diligence page.

FIG. 19 illustrates yet another example layout of the prepackaged due diligence page.

FIG. 20 illustrates yet another example layout of the prepackaged due diligence page.

FIG. 21 illustrates yet another example layout of the prepackaged due diligence page.

FIG. 22 illustrates an example layout of a browse asset page of the user interface.

FIG. 23 illustrates an example layout of an asset listing page of the user interface.

FIG. 24 illustrates an example layout of a seller asset management page of the user interface.

FIG. 25 illustrates an example layout of a bid management page of the user interface.

FIG. 26 illustrates an example layout of an incoming bid management page of the user interface

### DETAILED DESCRIPTION

Various embodiments will be described in detail with reference to the drawings, wherein like reference numerals represent like parts and assemblies throughout the several views.

In general, an online deal making platform in accordance with the present disclosure provides direct party-to-party (or company-to-company) transactions of assets, such as divestiture, acquisition, equity buy-in, licensing, swaps, and other possible deals. The assets subject to dealing made through the platform can be of various types, such as goods and services for and related to development, distribution, marketing, and/or sales. The online deal making platform provides prepackaged due diligence prior to entering an agreement. The prepackaged due diligence includes a questionnaire for each asset that is presented to and answered by a seller of the asset. The questionnaire is prepared for identifying material issues upfront. The platform is also configured to rate the asset in various aspects. Further, the platform provides a solution to maintain confidentiality of the information (e.g., the seller's answers and associated documents) about the asset and/or the seller thereof.

As such, the online deal making platform of the present disclosure improves upfront transaction certainty by identifying and selecting deals faster. For example, the platform allows searching target assets based on one or more criteria. Potential buyers can review and analyze the seller's frontloaded due diligence result, thereby identifying material issues and rating acceptable risk before entering an agreement with the seller.

The online deal making platform further provides a solution to proceed to deals faster. For example, the platform enables buyers to assess approvability and commercialibility of an asset in advance, and mitigate the risk of jumping into a deal with unknown outcomes by justifying the deal before expensive and time-consuming due diligence. Buyers using the platform can submit non-binding bid immediately after reviewing the seller's frontloaded due diligence result, greatly reducing the amount of time between when the buyer first learns of the asset and is able to confidently submit a bid. Similarly, sellers can receive bids on assets much more quickly after first making them available to potential buyers.

In some embodiments, the online deal making platform also allows the parties to interact anonymously with each other, at least for a period of time. In some embodiments the online deal making platform maintains the anonymity of the parties until a buyer's bid is accepted by the seller. Once a bid is accepted, the online deal making platform can reveal the parties' identities to each other. In other embodiments the parties are not anonymous.

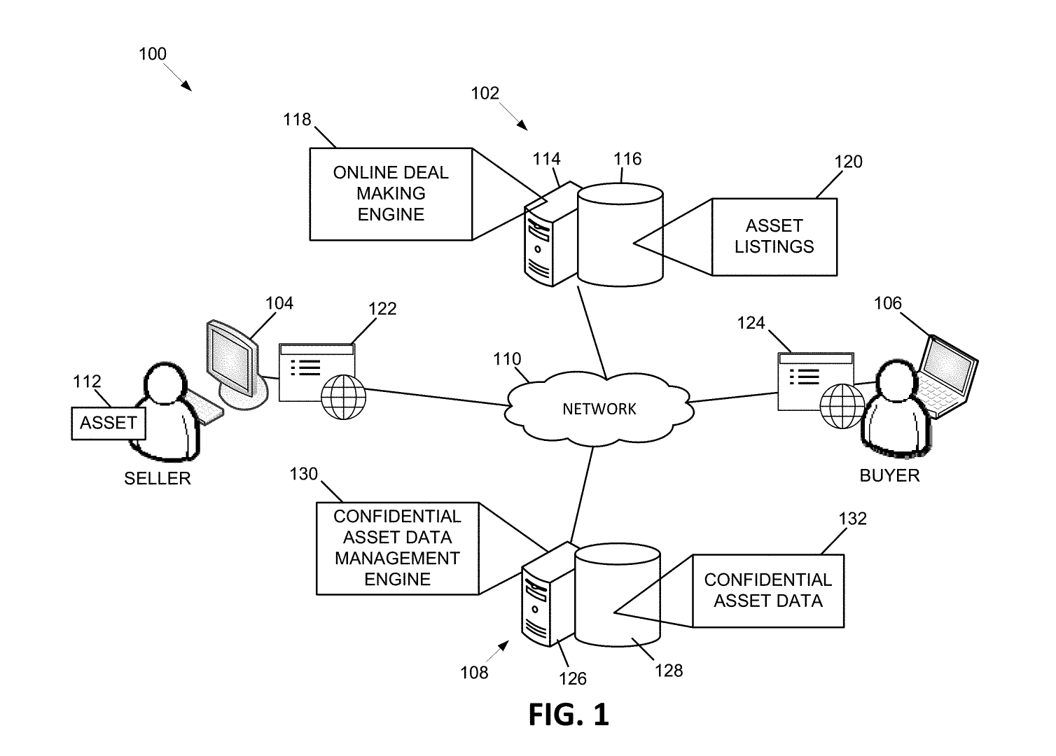

FIG. 1 illustrates a system 100 for online transaction in accordance with an exemplary embodiment of the present disclosure. In some embodiments, the system 100 includes an online deal making platform 102, a seller user computing device 104, a buyer user computing device 106, and a confidential asset data management system 108. A network 110 is provided to enable communications among the online deal making platform 102, the seller user computing device 104, the buyer user computing device 106, and the confidential asset data management system 108. Although the system 100 is illustrated to include a single seller user computing device 104 and a single buyer user computing device 106 in this embodiment, it is understood that the system 100 can include a plurality of seller user computing devices 104 and/or a plurality of buyer user computing devices 106.

The online deal making platform 102 operates to facilitate transactions between businesses. In the illustrated example, the platform 102 operates to facilitate a transaction of an asset 112 between a seller and a buyer.

The asset 112 that is subject to transactions through the platform 102 can be of various types. In some embodiments, the asset 112 includes a commodity, which is a good or service that has fungibility. Examples of the asset 112 includes raw materials, basic resources, agricultural products, generic and branded pharmaceuticals, and other commodities subject to various types of transaction. The asset 112 is subject to development, distribution, marketing, and/or sales. In some embodiments, the asset 112 requires an approval from a regulatory entity, such as the Food and Drug Administration (FDA) in the United States and the European Medicines Agency (EMA).

In some embodiments, the asset 112 subject to a potential transaction through the online deal making platform 102 includes information that needs to be kept confidential during and after a transaction between the seller and the buyer. As described herein, the system 100 provides a system for maintaining the information about the asset 112 to be confidential.

The transaction of the asset 112 can be of various forms, such as divestiture, acquisition, equity buy-in, licensing, swaps, and other possible deals.

The online deal making platform 102 includes a server 114 and a database 116.

The server 114 operates to perform various processes related to facilitating asset transactions between users. The server 114 is a computing device that includes a database software application, such as the SQL SERVER® database software distributed by MICROSOFT® Corporation. In at least some embodiments, the server 114 includes a Web server or a file server. In some embodiments, the server 114 comprises a plurality of computing devices that are located in one or more physical locations. For example, the server 114 can be a single server or a bank of servers.

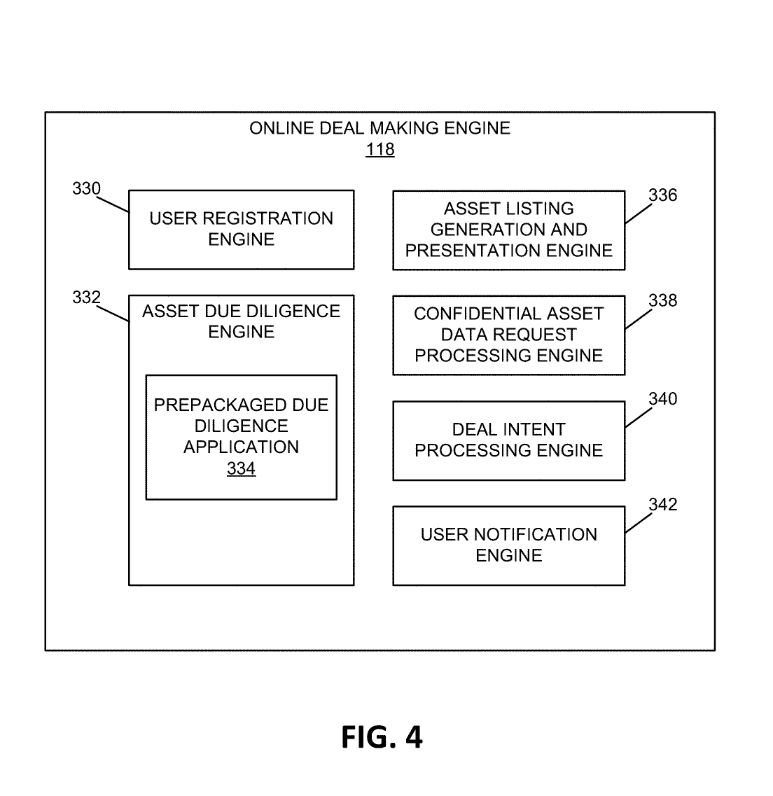

In the illustrated example, the server 114 includes an online deal making engine 118. The online deal making engine 118 operates to generate interfaces and perform processes associated with an online transaction between the seller and the buyer. An example of the online deal making engine 118 is further illustrated and describe with reference to FIG. 4.

The database 116 is a data storage device configured to store data related to users, assets (e.g., asset listings 120), and transactions. Examples of the database 116 include a hard disk drive, a collection of hard disk drives, digital memory (such as random access memory), a redundant array of independent disks (RAID), optical or solid state storage devices, or other data storage devices. The data can be distributed across multiple local or remote data storage devices. The database 116 stores data in an organized manner, such as in a hierarchical or relational database structure, or in lists and other data structures such as tables. The database 116 can be stored on a single data storage device or distributed across two or more data storage devices that are located in one or more physical locations. The database 116 can be a single database or multiple databases. In at least some embodiments, the database 116 is located on the server 114. In other embodiments, the server 114 and the database 116 communicate with each other via a local area network or a wide area network.

The seller user computing device 104 operates to allow the seller to access the online deal making platform 102. The seller user computing device 104 is connected to the network 110. The seller user computing device 104 may connect to the network 110 using a wired or wireless interface. In some embodiments, the seller user computing device 104 accesses the online deal making platform 102 through a Web interface 122 using a Web browser. In other embodiments, the seller user computing device 104 accesses the online deal making platform 102 using an application. Other embodiments are possible as well.

As described herein, the seller can use the seller user computing device 104 to upload an asset 112 by performing prepackaged due diligence provided by the online deal making platform 102.

Similarly, the buyer user computing device 106 operates to allow the buyer to access the online deal making platform 102. The buyer user computing device 106 is connected to the network 110. The buyer user computing device 106 may connect to the network 110 using a wired or wireless interface. In some embodiments, the buyer user computing device 106 accesses the online deal making platform 102 through a Web interface 124 using a Web browser. In other embodiments, the buyer user computing device 106 accesses the online deal making platform 102 using an application. Other embodiments are possible as well.

In some embodiments, sellers include lessors and buyers include lessees. In some embodiments, a single user can be both a seller of one transaction and a buyer of another transaction.

The confidential asset data management system 108 operates to store information about the asset 112. In some embodiments, the confidential asset data management system 108 is configured to store confidential information (including the seller's proprietary information in some embodiments) about the asset 112 that is provided by the seller, so that the confidential information is not available to the buyer or other users in general and becomes accessible under limited circumstances. In this way, confidential information about the asset 112 can be reliably protected.

The confidential asset data management system 108 includes a server 126 and a database 128. The server 126 can be configured similarly to the server 114, and the database 128 can be configured similarly to the database 116. Therefore, the description of the server 126 and the database 128 is omitted for brevity purposes.

In the illustrated example, the server 126 includes a confidential asset data management engine 130 configured to generate interfaces and perform processes for storing confidential information about the asset 112 and retrieving the confidential information as necessary.

In the illustrated example, the database 128 stores confidential asset data 132. The confidential asset data 132 can include confidential information about the asset 112, users (e.g., sellers and/or buyers), and transactions.

Referring still to FIG. 1, the network 110 communicates digital data between one or more computing devices, such as the online deal making platform 102, the seller user computing device 104, the buyer user computing device 106, and the confidential asset data management system 108. The network 110 can be a local area network or a wide area network, such as the Internet.

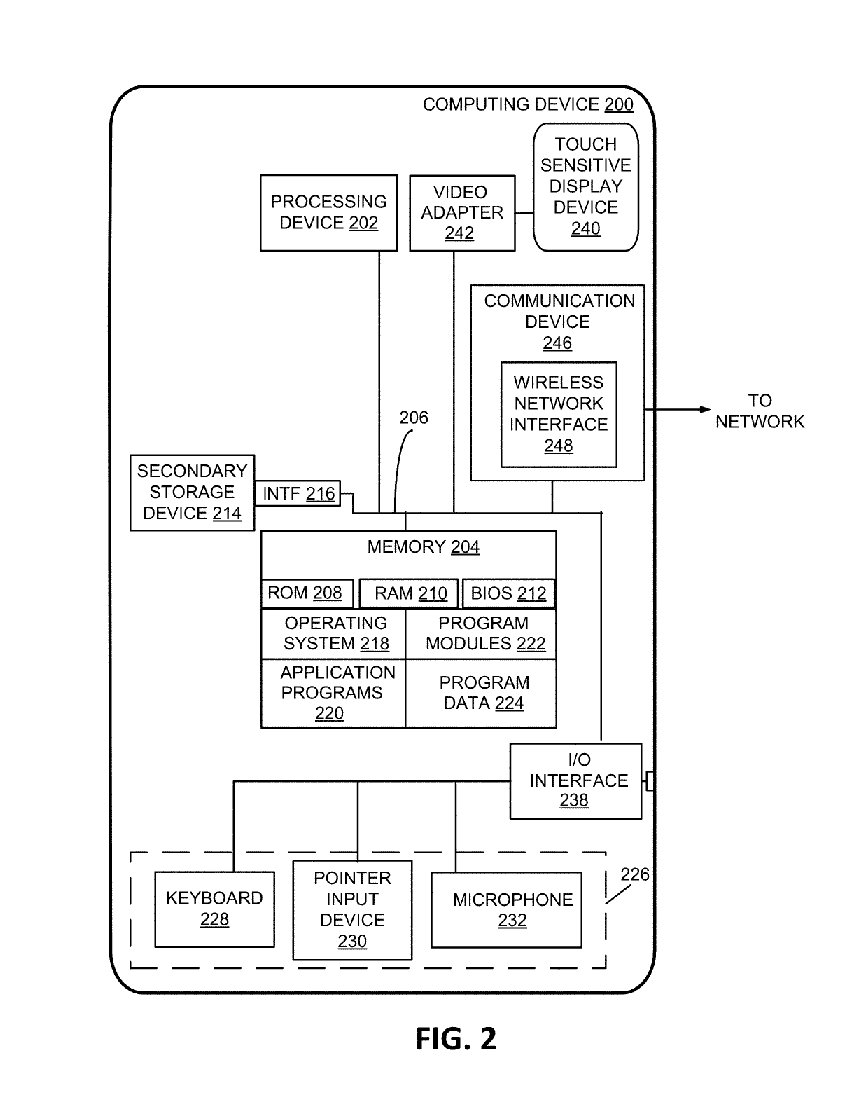

FIG. 2 illustrates an exemplary architecture of a computing device that can be used to implement aspects of the present disclosure, including the online deal making platform 102, the seller user computing device 104, the buyer user computing device 106, and the confidential asset data management system 108. Further, one or more devices or units included in the system 100 can also be implemented with at least some components of the computing device as illustrated in FIG. 2. Such a computing device is designated herein as reference numeral 200. The computing device 200 is used to execute the operating system, application programs, and software modules (including the software engines) described herein.

The computing device 200 includes, in some embodiments, at least one processing device 202, such as a central processing unit (CPU). A variety of processing devices are available from a variety of manufacturers, for example, Intel or Advanced Micro Devices. In this example, the computing device 200 also includes a system memory 204, and a system bus 206 that couples various system components including the system memory 204 to the processing device 202. The system bus 206 is one of any number of types of bus structures including a memory bus, or memory controller; a peripheral bus; and a local bus using any of a variety of bus architectures.

Examples of computing devices suitable for the computing device 200 include a desktop computer, a laptop computer, a tablet computer, a mobile device (such as a smart phone, an iPod® mobile digital device, or other mobile devices), or other devices configured to process digital instructions.

The system memory 204 includes read only memory 208 and random access memory 210. A basic input/output system 212 containing the basic routines that act to transfer information within computing device 200, such as during start up, is typically stored in the read only memory 208.

The computing device 200 also includes a secondary storage device 214 in some embodiments, such as a hard disk drive, for storing digital data. The secondary storage device 214 is connected to the system bus 206 by a secondary storage interface 216. The secondary storage devices and their associated computer readable media provide nonvolatile storage of computer readable instructions (including application programs and program modules), data structures, and other data for the computing device 200.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 214 or memory 204, including an operating system 218, one or more application programs 220, other program modules 222, and program data 224.

In some embodiments, computing device 200 includes input devices to enable a user to provide inputs to the computing device 200. Examples of input devices 226 include a keyboard 228, pointer input device 230, microphone 232, and touch sensitive display 240. Other embodiments include other input devices 226. The input devices are often connected to the processing device 202 through an input/output interface 238 that is coupled to the system bus 206. These input devices 226 can be connected by any number of input/output interfaces, such as a parallel port, serial port, game port, or a universal serial bus. Wireless communication between input devices and interface 238 is possible as well, and includes infrared, BLUETOOTH® wireless technology, WiFi technology (802.11a/b/g/n etc.), cellular, or other radio frequency communication systems in some possible embodiments.

In this example embodiment, a touch sensitive display device 240 is also connected to the system bus 206 via an interface, such as a video adapter 242. The touch sensitive display device 240 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 240, the computing device 200 can include various other peripheral devices (not shown), such as speakers or a printer.

The computing device 200 further includes a communication device 246 configured to establish communication across the network. In some embodiments, when used in a local area networking environment or a wide area networking environment (such as the Internet), the computing device 200 is typically connected to the network through a network interface, such as a wireless network interface 248. Other possible embodiments use other wired and/or wireless communication devices. For example, some embodiments of the computing device 200 include an Ethernet network interface, or a modem for communicating across the network. In yet other embodiments, the communication device 246 is capable of short-range wireless communication. Short-range wireless communication is one-way or two-way short-range to medium-range wireless communication. Short-range wireless communication can be established according to various technologies and protocols. Examples of short-range wireless communication include a radio frequency identification (RFID), a near field communication (NFC), a Bluetooth technology, and a Wi-Fi technology.

The computing device 200 typically includes at least some form of computer-readable media. Computer readable media includes any available media that can be accessed by the computing device 200. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

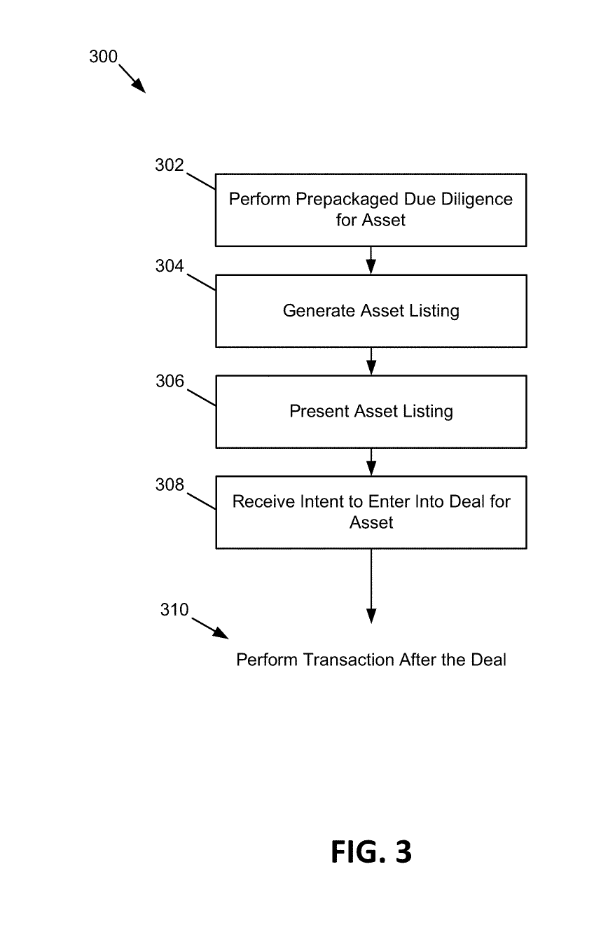

FIG. 3 is a flowchart of an example method 300 for operating the system 100. In this example, the method 300 is described to be performed primarily by the online deal making platform 102, such as the online deal making engine 118 thereof. In other examples, the method 300 can be performed by one or more other computing devices in the system 100 with or without the online deal making platform 102.

At operation 302, the online deal making platform 102 operates to perform prepackaged due diligence for an asset 112. As described herein, the prepackaged due diligence includes a questionnaire about the asset 112 that is provided to the seller via the seller user computing device 104, and the due diligence for the asset 112 is performed by the seller who answers the questions via the seller user computing device 104. In some embodiments, the seller's answers include confidential information that needs to be kept confidential. In some embodiments, the confidential information includes the seller's proprietary information.

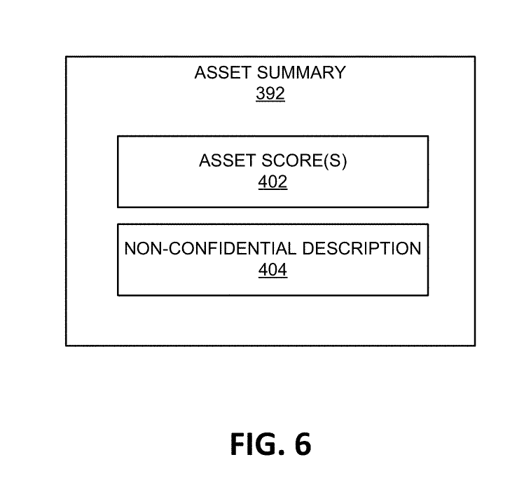

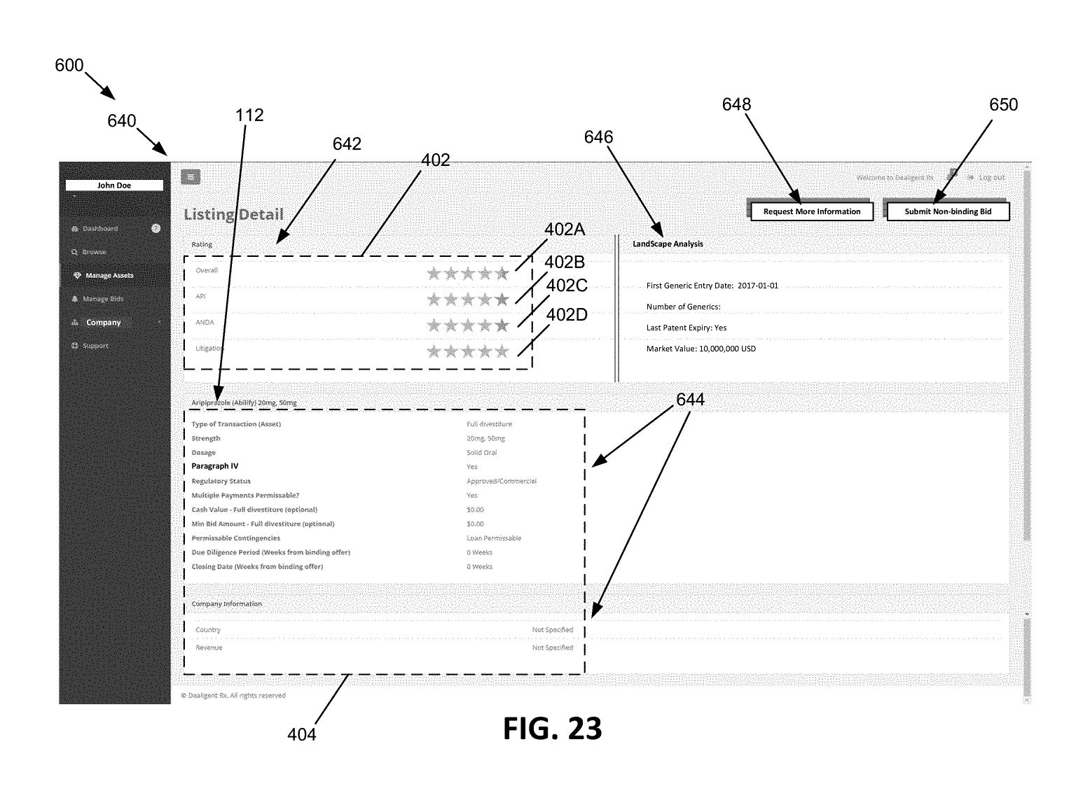

At operation 304, the online deal making platform 102 operates to generate an asset listing 120 for the asset 112. The asset listing 120 can include information about the asset 112 that represents the evaluation of the asset 112. In some embodiments, the information about the asset 112 is generated based on the seller's answers to the questions included in the prepackaged due diligence. The information about the asset 112 in the asset listing 120 can include a summary of the asset 112 that is generated based at least partially on the confidential information while the summary of the asset 112 does not reveal the confidential information. In some embodiments, the summary of the asset 112 includes at least one asset score (also referred to herein as rating) 402 (FIGS. 6 and 23) that evaluates the asset 112 in a numerical way. Various aspects of the asset 112 can be evaluated with asset scores, respectively.

At operation 306, the online deal making platform 102 operates to present the asset listing 120 so that the buyer can review the asset 112 based on the information shown in the asset listing 120. In some embodiments, the buyer can request additional information about the asset 112 under certain circumstances, such as by paying a fee, obtaining permission from the seller, or obtaining permission from the online deal making platform 102 in other ways.

At operation 308, the online deal making platform 102 operates to receive an intent to enter into an agreement for the asset 112. In some embodiments, the online deal making platform 102 operates to receive the buyer's intent to enter into a deal for the asset 112, and then receive the seller's intent to enter into the deal for the asset 112. In other embodiments, the online deal making platform 102 operates to receive the seller's intent to enter into a deal for the asset 112, and then receive the buyer's intent to enter into the deal for the asset 112. The online deal making platform 102 can operate to generate a user interface (e.g., a graphical user interface on the Web interface 122, 124) on the seller user computing device 104 and/or the buy user computing device 106 to receive the offer and acceptance from the seller and buyer.

In some embodiments, the agreement reached at the operation 308 is a non-binding deal. The seller and the buyer can perform further transactions after entering the non-binding agreement. In some embodiments, such further transactions can be conducted at least partially using the system 100. In other embodiments, the further transactions after the non-binding agreement are performed directly between the seller and the buyer outside the system 100.

In another possible embodiment the method 300 does not include operation 308. Instead, once the buyer has reviewed the asset listing in operation 306, the buyer can request direct contact with the seller, such as to interact directly with each other to inquire about and/or negotiate regarding the asset 112. In this alternative the system 100 can provide contact information or messages can be sent between the parties to permit the parties to exchange contact information. Even when direct communication is utilized, the parties may still choose to resume use of the system. For example, the seller may direct the buyer to review certain information from the data room, or the buyer may choose to continue the process by submitting a bid through the system 100.

In another possible embodiment, operation 306 can include presenting the asset listing through a third party system. For example, the system 100 can provide a feed or application programming interface (API) allowing access to public data associated with the asset listing, to permit the asset listing to be displayed on third party systems, which will in turn link back to the system 100. In one example an XML feed is provided formatted as an ATOM, RSS, or other type of data feed, and third parties can subscribe to the feed, receive the public data associated with the asset listing, and use that data to generate a listing on the third party system relating to the asset. The data includes a link that is displayed with the listing, and upon selection of the link a user is redirected to the system 100 where the asset listing is presented as discussed in operation 306.

FIG. 4 is a block diagram of an example architecture of the online deal making engine 118. The online deal making engine 118 includes one or more engines (or modules) that, when executed by the processing device 202 (shown in FIG. 2), perform one or more operations of the server 114. In this example, the online deal making engine 118 includes a user registration engine 330, an asset due diligence engine 332 including a prepackaged due diligence application 334, an asset listing generation and presentation engine 336, a confidential asset data request processing engine 338, a deal intent processing engine 340, and a user notification engine 342. At least some embodiments include more, fewer, or different engines than those shown in FIG. 4.

In some embodiments, at least some of the engines of the online deal making engine 118 can be implemented through a Web interface (e.g., the Web interface 122, 124) using a Web browser so that the seller can access the online deal making platform 102 using the seller user computing device 104 and that the buyer can access the online deal making platform 102 using the buyer user computing device 106.

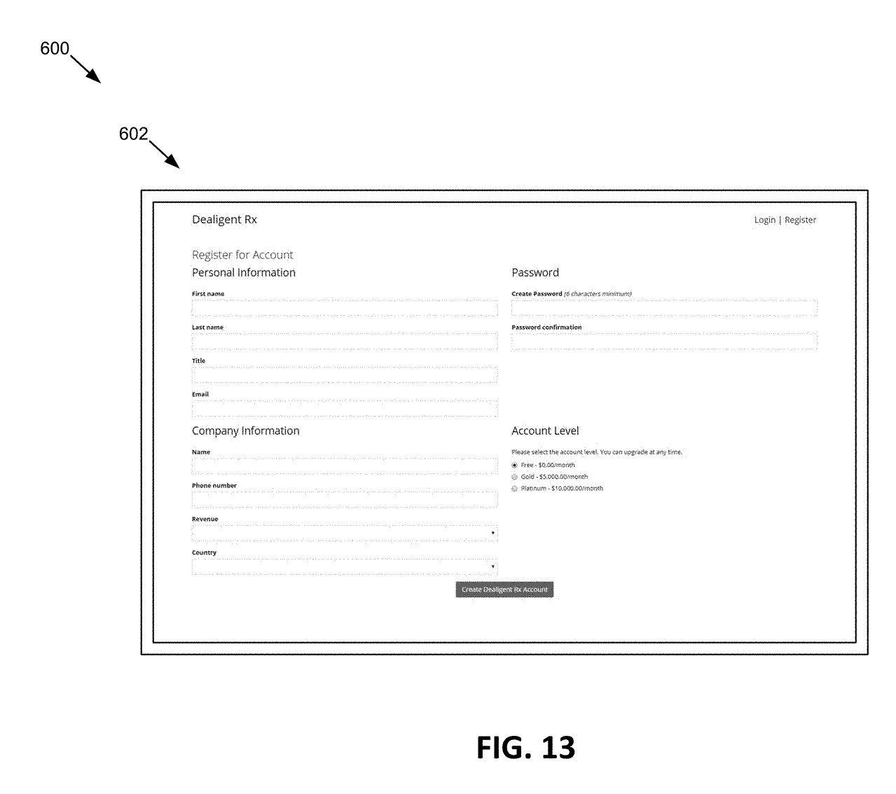

The user registration engine 330 operates to prompt users (e.g., the seller and the buyer) to register in the online deal making platform 102. In some embodiments, the user registration engine 330 can generate user interfaces (e.g., the Web interface 122, 124) on user computing devices (e.g., the seller user computing device 104 and the buy user computing device 106) to receive information of the users. An example user interface is described and illustrated with reference to FIG. 13.

The asset due diligence engine 332 operates to perform due diligence for the asset 112. The due diligence can be performed when the seller posts a new asset 112 in the online deal making platform 102. In this example, the asset due diligence engine 332 includes the prepackaged due diligence application 334.

The prepackaged due diligence application 334 provides a list of questions (also referred to herein as a questionnaire) about the asset 112 so that the seller can answer the questions. At least some of the seller's answers can be used to perform due diligence for the asset 112. In some embodiments, the list of questions is generated and stored in the online deal making platform 102.

The list of questions can be configured to ask various aspects of the asset 112, which are suitable for assessing the asset 112 in terms of, for example, approvability by a regulatory entity, commercialibity, marketability, legal status, and other facts, natures, and characteristics of the asset. As described herein, the questions can be categorized into different sections. In some embodiments, the questions in each section can be used to determine an asset score with respect to that section.

In some embodiments, the asset due diligence engine 332 further operates to store the information (e.g., the seller's answers) about the asset 112 collected by the prepackaged due diligence application 334. Moreover, the asset due diligence engine 332 operates to process the information (e.g., the seller's answers) about the asset 112 collected by the prepackaged due diligence application 334, and generates an asset summary of the asset 112. The asset summary is used to generate the asset listing 120 for the asset 112.

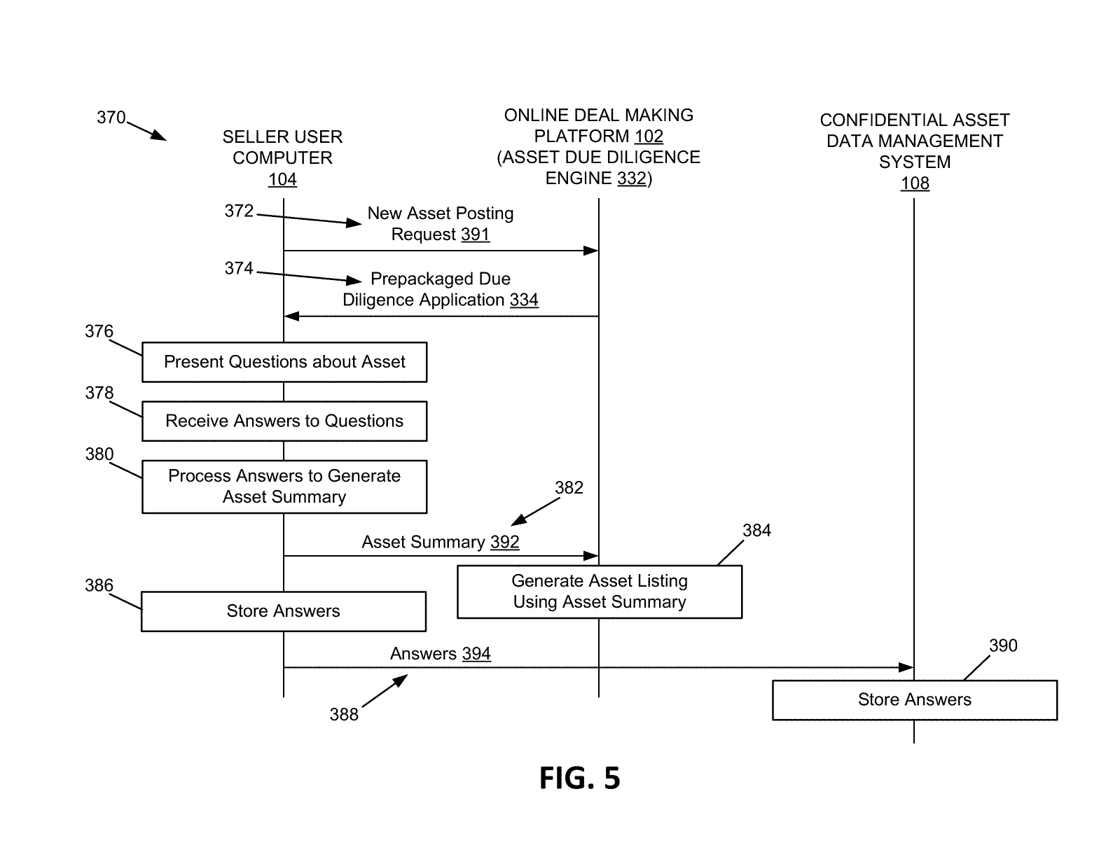

An example operation of the asset due diligence engine 332 is further described with reference to FIG. 5.

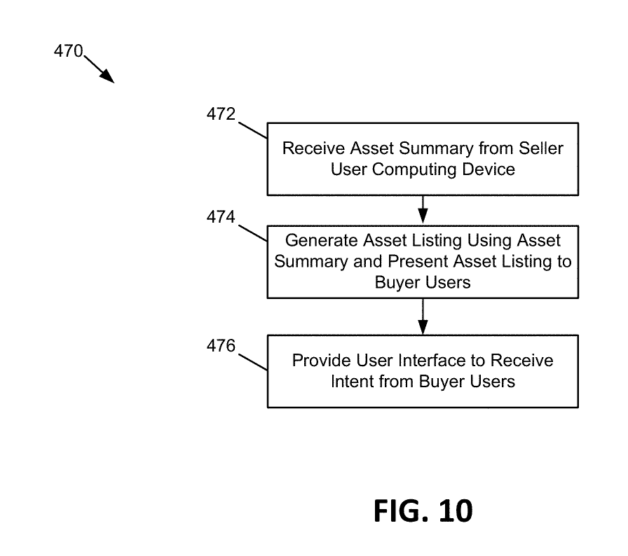

Referring still to FIG. 4, the asset listing generation and presentation engine 336 operates to generate the asset listing 120 and present it to the buyer. An example operation of the asset listing generation and presentation engine 336 is further described with reference to FIG. 10.

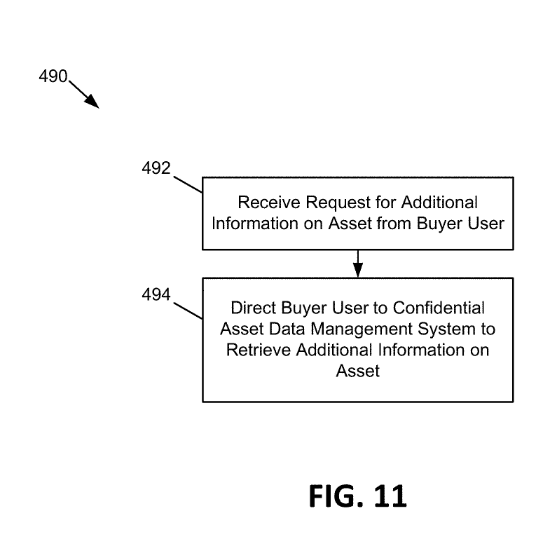

The confidential asset data request processing engine 338 operates to retrieve confidential information associated with the asset 112 upon request. In some embodiments, confidential information associated with the asset 112 can be stored in a database separate from the online deal making platform 102, which can be the confidential asset data management system 108 (FIG. 1) in this example. In some examples, the confidential asset data request processing engine 338 operates to receive a request from the buyer to obtain additional information about the asset 112 and, upon request, direct the buyer to the database (e.g., the confidential asset data management system 108) to retrieve at least some of the confidential information about the asset 112. An example operation of the confidential asset data request processing engine 338 is further described with reference to FIG. 11.

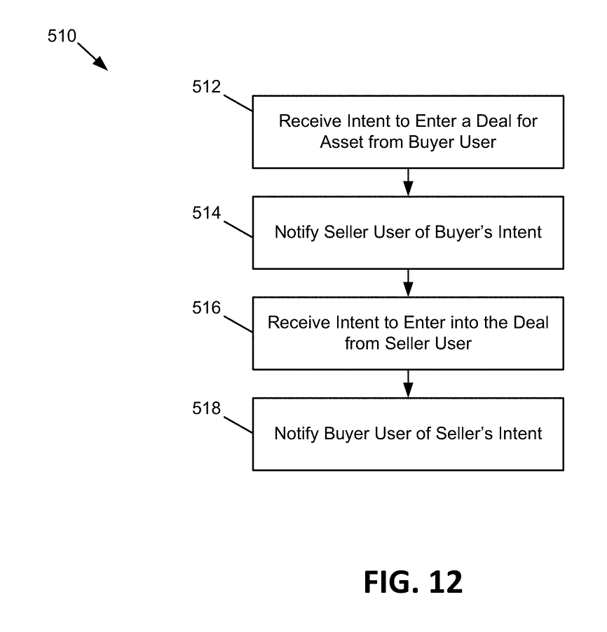

The deal intent processing engine 340 operates to receive at least one of the seller's intent and the buyer's intent to enter into an agreement for the asset 112, and finalize the intended agreement between the seller and the buyer. An example operation of the deal intent processing engine 340 is further described with reference to FIG. 12.

The user notification engine 342 operates to generate a notification to a user, such as the seller and the buyer. In some embodiments, the user notification engine 342 notifies a user of another user's intent to enter a deal for the asset 112. An example operation of the user notification engine 342 is further described with reference to FIG. 12.

In some embodiments the online deal making engine 118 includes an analytics engine. The analytics engine operates to track, record, and analyze data associated with assets, transactions, questionnaires, answers to questionnaires, pricing of assets, and success (or lack thereof) of transactions. Further the analytics engine can also include predictive analytics, such as to predict a price of a successful transaction through the system 100 for a given asset, or for a wide variety of other possible data analytics purposes. The analytics engine can use machine learning algorithms for predictive analytics. In one example, the machine learning algorithms are trained on the data of past assets and transactions, for example. Other algorithms and training processes and data can be used in other embodiments.

FIG. 5 is a flowchart of an example method 370 of performing the asset due diligence engine 332 included in the online deal making platform 102.

At operation 372, the asset due diligence engine 332 operates to receive a request 391 from the seller via the seller user computing device 104 to post a new asset 112.

At operation 374, the asset due diligence engine 332 operates to transmit the prepackaged due diligence application 334 to the seller user computing device 104. In some embodiments, the prepackaged due diligence application 334 is executed through the Web interface 122 using a Web browser running on the seller user computing device 104.

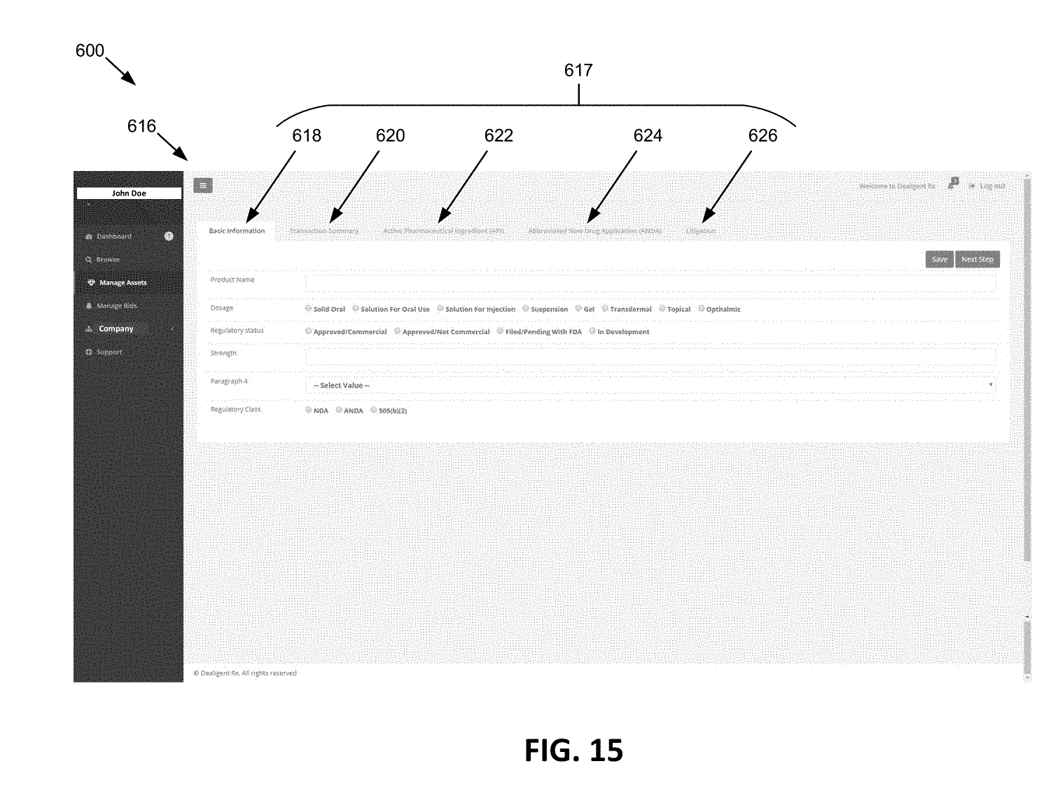

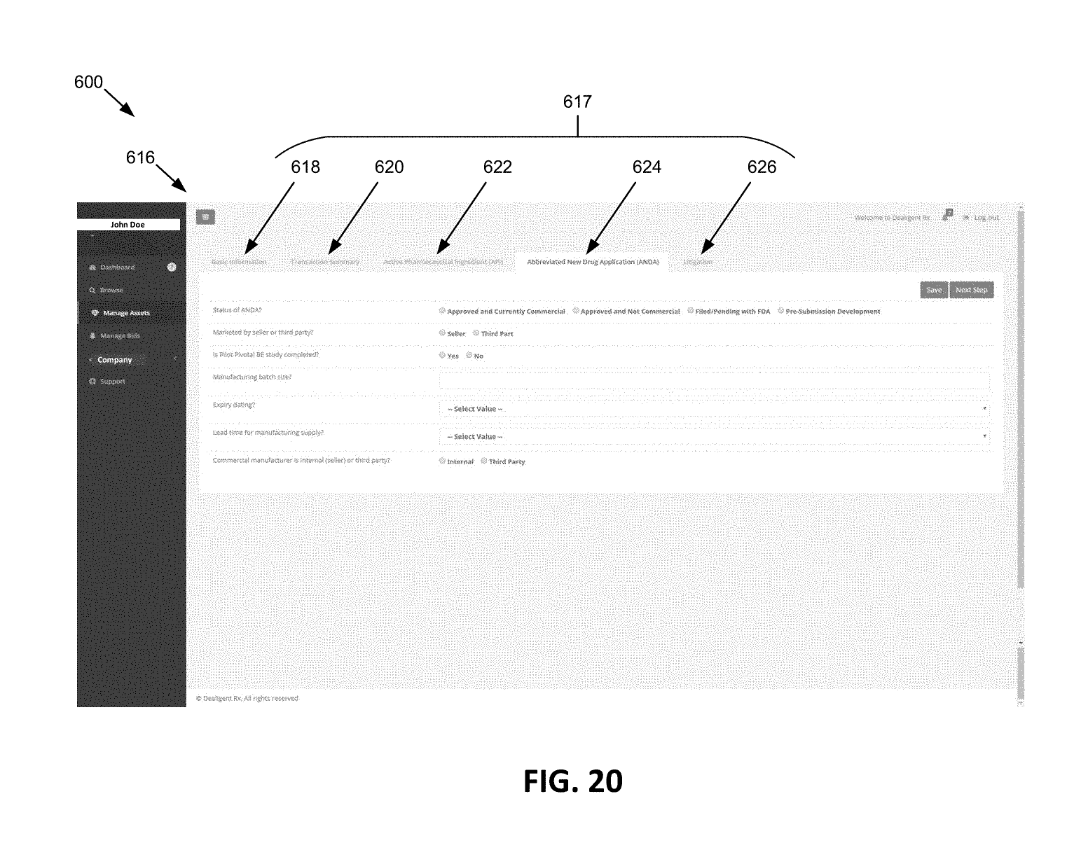

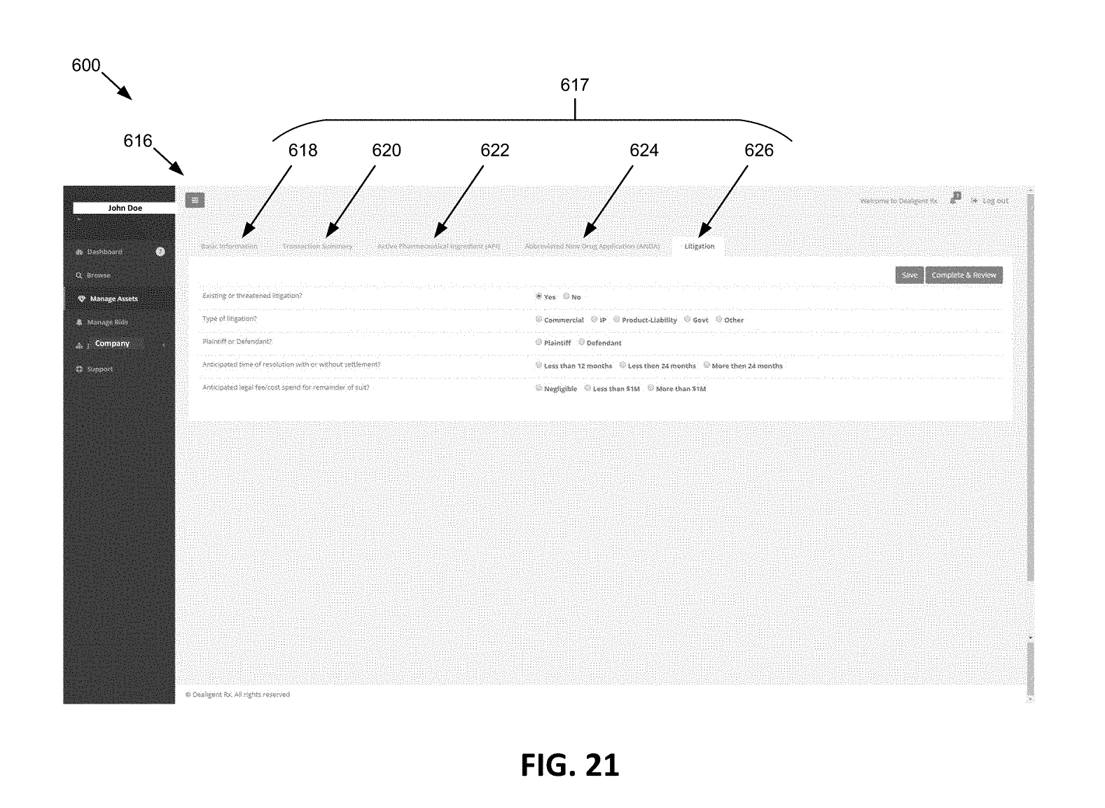

At operation 376, the asset due diligence engine 332 operates to present questions about the asset 112 to the seller using the seller user computing device 104. At operation 378, the asset due diligence engine 332 operates to receive answers 394 to the questions from the seller. In some embodiments, the asset due diligence engine 332 prompts the seller to enter an input for each of the questions using the seller user computing device 104. An example user interface for performing the operations 376 and 378 are illustrated in FIGS. 15-21.

In some embodiments, the answers 394 include confidential information associated with the asset 112, which is also referred to herein confidential asset information. In some embodiments, the confidential information also include proprietary information of the asset and/or the seller thereof. As described herein, the confidential asset information can be stored as confidential asset data 132 in the confidential asset data management system 108. Further, in some embodiments, the confidential asset information is not sent to the online deal making platform. As such, the confidential asset information is segregated from non-confidential asset information and is not disclosed to buyers or other uses unless a predetermined condition is met. By way of example, the confidential asset information is available only to buyers who pay fees or obtain permission.

At operation 380, the asset due diligence engine 332 operates to process the seller's answers to generate an asset summary 392. The asset summary 392 includes information that summarizes various aspects of the asset 112. As described herein, the asset summary 392 can be generated based at least in part on the confidential asset information. In some embodiments, the asset summary 392 does not directly disclose the confidential asset information.

At operation 382, the asset due diligence engine 332 prompts the seller user computing device 104 to transmit the asset summary 392 to the online deal making platform 102. In some embodiments, the confidential information about the asset 112 is not transmitted to the online deal making platform 102 while the asset summary 392 is sent to the online deal making platform 102. As such, the online deal making platform 102 operates to not store any confidential information associated with the asset 112, thereby maintaining confidentiality of the seller's asset 112 against the buyer (until certain condition is met) and other users in the online deal making platform 102.

At operation 384, the asset due diligence engine 332 operates to generate an asset listing 120. The asset listing 120 includes the asset summary 392. An example of the asset summary 392 is further described with reference to FIG. 6.

At operation 386, the asset due diligence engine 332 prompts the seller user computing device 104 to store the seller's answers 394 locally in the seller user computing device 104.

At operation 388, the asset due diligence engine 332 prompts the seller user computing device 104 to transmit at least some of the seller's answers 394 to the confidential asset data management system 108. At operation 390, the confidential asset data management system 108 operates to store the received answers 394 therein.

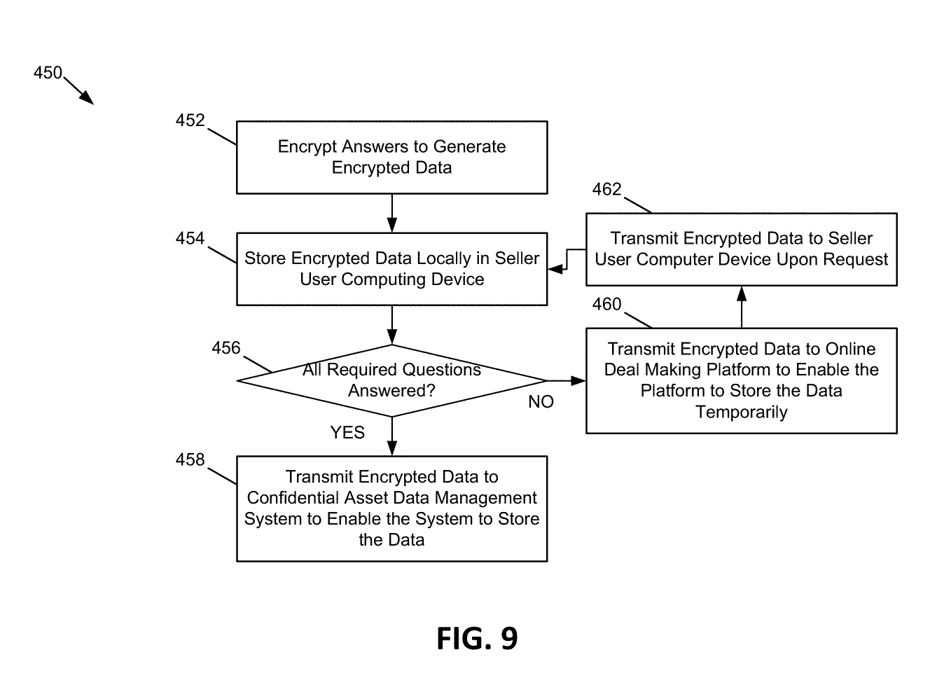

An example method of performing the operations 386, 388, and 390 are further described with reference to FIG. 9.

FIG. 6 is a block diagram of example contents of the asset summary 392. In this example, the asset summary 392 includes at least one asset score (also referred to herein as rating) 402 and a non-confidential description 404.

The asset score 402 can be a numerical value that evaluates the asset 112. The asset score 402 can be configured to represent assessment of the asset 112 in various aspects, such as approvability and commercialibility. The asset score 402 can indicate the aspects of the asset 112 without disclosing any confidential information about the asset 112.

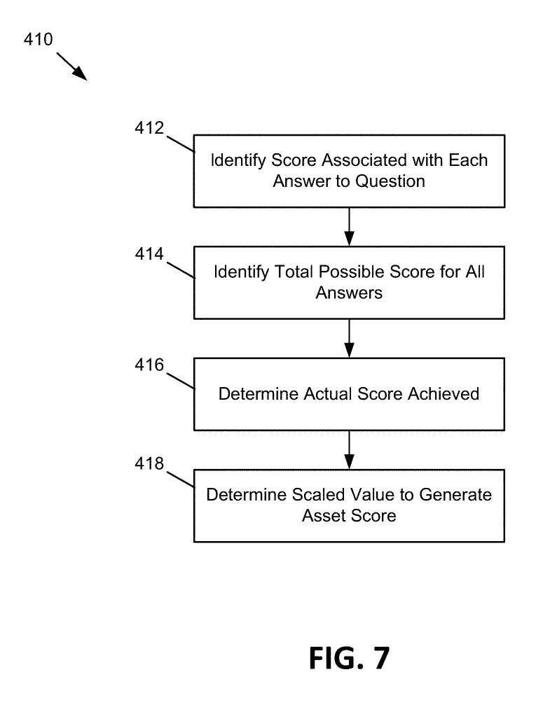

In some embodiments, the asset score 402 can be a scaled value, such as one (1) to five (5). In other embodiments, the asset score 402 can be a percentage value. In yet other embodiments, the asset score 402 can be a numerical value within a range. In yet other embodiments, the asset score 402 can be a value with or without a minimum value and/or a maximum value. An example representation of the asset score 402 is illustrated in FIG. 23. An example method of obtaining the asset score 402 is further described with reference to FIG. 7.

The non-confidential description 404 is a description about the asset 112 that need not be confidential. The non-confidential description 404 can include non-confidential information about the asset 112, and/or can be generated based at least in part on confidential information about the asset 112. In some embodiments, such non-confidential information and confidential information about the asset 112 can be obtained at least in part from the seller's answers to the questionnaire.

FIG. 7 is a flowchart of an example method 410 for obtaining the asset score 402 associated with the asset 112. As described herein, in some embodiments, the asset score 402 can be determined by the asset due diligence engine 332 of the online deal making platform 102. Other computing devices can perform the method 410 in other embodiments.

At operation 412, the asset due diligence engine 332 identifies each of individual scores associated with all possible answers to each question in the questionnaire provided by the prepackaged due diligence application 334.

At operation 414, the asset due diligence engine 332 determines a total maximum score that is possible for answers to all the questions required to be answered. The total maximum score can be calculated by summing up all of the highest scores possible for all the questions required to be answered in the questionnaire. In some embodiments, only some of the questions in the questionnaire are required to be answered by the seller to complete the posting of the asset. In other embodiments, all of the questions in the questionnaire are required to be answered by the seller to complete the posing of the asset.

At operation 416, the asset due diligence engine 332 determines an actual score for all the questions required to be answered. The actual score can be calculated by summing up all of the scores assigned to the actual answers by the seller to all the questions required to be answered.

At operation 418, the asset due diligence engine 332 operates to determine a scaled value by dividing the actual score by the total maximum score. In this example, the scaled value can range from zero (0) to one (1). The scaled value is converted to the asset score 402 in various formats, such as a rating system (e.g., one (1) to five (5)) as illustrated in FIG. 23. By way of example the scaled value can be proportionally converted to a predetermined format of the asset score 402.

Although the method 410 is primarily described to obtain a single asset score, a plurality of asset scores 402 can be obtained for different aspects of the asset 112. In examples where the asset 112 is a pharmaceutical commodity, the asset scores 402 can include an overall score 402A, an API score 402B, an ANDA score 402C, and a litigation score 402D, as illustrated in FIG. 23.

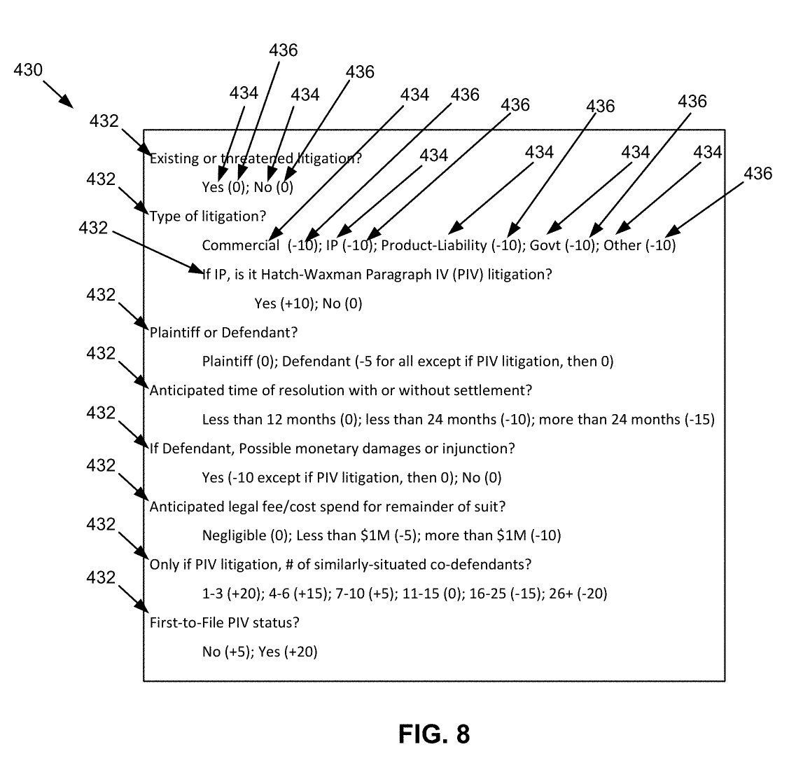

FIG. 8 illustrates an example list 430 (i.e., a questionnaire) of questions with possible answers and scores assigned to the answers. In this example, the list 430 of questions is configured to evaluate a litigation aspect of the asset 112. The list 430 of questions in this example is for illustration only and does not limit possible questionnaires in accordance with the present disclosure. In the example, the list 430 includes a plurality of questions 432. For each question 432, a plurality of possible answers 434 are provided, and a score 436 is assigned to each of the possible answers 434. As the seller provides answers to the questions one-by-one, the scores 436 assigned to the seller's answers are accumulated to provide the actual score (at the operation 416 in FIG. 7) when the seller answers all the questions required in the questionnaire 430.

FIG. 9 is a flowchart of an example method 450 for storing information of the asset 112. In some embodiments, the method 450 is performed to store the seller's answers to the questionnaire about the asset 112, as illustrated as the operations 386, 388, and 390 in FIG. 5. As described herein, in some embodiments, the method 450 can be performed by the asset due diligence engine 332 of the online deal making platform 102. Other computing devices can perform the method 450 in other embodiments.

At operation 452, the asset due diligence engine 332 operates to encrypt the answers to generate encrypted data. In some embodiments, the answers are encrypted with a decryption key, and the decryption key can be associated with the seller user computing device 104. In some embodiments the decryption key is only stored on the seller user computing device 104. In other possible embodiments the decryption key can also or alternatively be saved at one or more other locations, such as at the online deal making engine 118 (server 114, FIG. 1) and/or the confidential asset data management engine 130 (server 126, FIG. 1). In some embodiments the decryption key is stored and transmitted along with the seller's answers to the due diligence questionnaire, on whatever computing device or computer-readable storage device the seller's answers reside.

At operation 454, the asset due diligence engine 332 operates to store the encrypted data locally in the seller user computing device 104. In some embodiments, while the seller goes through the questions in the questionnaire, the asset due diligence engine 332 periodically encrypts the answers so far and store the encrypted data in the seller user computing device 104.

In some embodiments, the encrypted data is locally saved in the seller user computing device 104 until all the questions required to be answered have been answered by the seller. In other embodiments, the encrypted data is locally saved in the seller user computing device 104 even after all the questions required to be answered have been answered by the seller.

At operation 456, the asset due diligence engine 332 operates to determine if all the required questions are answered by the seller. If it is determined that all the required questions are answered (“YES”), the method 450 continues at operation 458. Otherwise (“NO), the method 450 moves on to operation 460.

At operation 458, the asset due diligence engine 332 operates to transmit the encrypted data to the confidential asset data management system 108 so that the asset due diligence engine 332 stores the encrypted data.

At operation 460, the asset due diligence engine 332 operates to transmit the encrypted data to the online deal making platform 102 so that the online deal making platform 102 stores the encrypted data therein. In some embodiments, the online deal making platform 102 can store the encrypted data temporarily until the online deal making platform 102 receives a request from the seller user computing device 104 retrieve the encrypted data.

At operation 462, the asset due diligence engine 332 operates to transmit the stored encrypted data to the seller user computing device 104 when receiving a request from the seller user computing device 104 to retrieve the stored encrypted data.

By way of example, the seller may pause to go through and answer the questions before all the questions are reviewed in the questionnaire. Then, the seller user computing device 104 can locally store the encrypted data for the answers for the answered questions, as illustrated in the operation 454. In addition or alternatively, the encrypted data for the answers for the answered questions can be transmitted to the online deal making platform 102, which stores the encrypted data, and the encrypted data stored in the seller user computing device 104 may or may not be removed in the meantime. In cases where the seller user computing device 104 does not have the encrypted data stored locally, the seller user computing device 104 can transmit a request to the online deal making platform 102 to retrieve the encrypted data. Once the seller user computing device 104 receives the encrypted data, the seller user computing device 104 can continue to prompt the seller to answer the remaining questions in the questionnaire and/or edit the answers in the questionnaire.

FIG. 10 is a flowchart of an example method 470 for generating an asset listing 120 (FIG. 1). In some embodiments, the method 470 is used to perform the operation 384 in FIG. 5. As described herein, in some embodiments, the method 470 can be performed by the listing generation and presentation engine 336 (FIG. 4) of the online deal making platform 102. Other computing devices can perform the method 470 in other embodiments.

At operation 472, the listing generation and presentation engine 336 operates to receive the asset summary 392 from the seller user computing device 104.

At operation 474, the listing generation and presentation engine 336 operates to generate an asset listing 120 using the asset summary 392, and present the asset listing 120 to buyer users. An example of the asset listing 120 is illustrated with reference to FIG. 23. In some embodiments the asset listing 120 does not identify the seller, but maintains the anonymity of the seller in the listing. In other embodiments the identity of the seller is not anonymous. In yet another possible embodiment, the seller is prompted to identify whether the asset listing 120 should identify the seller, or whether the sellers identity should be kept anonymous. The system then operates to display the sellers identity or maintain the anonymity according to the seller's selection.

At operation 476, the listing generation and presentation engine 336 operates to provide a user interface to receive an intent from a buyer user to enter into an agreement with the seller regarding the asset 112. An example of the user interface for receiving the buyer's intent is illustrated with reference to FIG. 23 (a control element 650).

FIG. 11 is a flowchart of an example method 490 for requesting additional information about the asset 112. As described herein, in some embodiments, the method 490 can be performed by the confidential asset data request processing engine 338 (FIG. 4) of the online deal making platform 102. Other computing devices can perform the method 490 in other embodiments.

At operation 492, the confidential asset data request processing engine 338 operates to receive a request from the buyer via the buyer user computing device 106, the request for additional information about the asset 112. In some embodiments, a user interface is provided, which is selectable by the buyer using the buyer computing device 106 to request additional information about the asset 112. An example of the user interface is illustrated in FIG. 23 (a control element 648).

At operation 494, upon receiving the request from the buyer, the confidential asset data request processing engine 338 operates to direct the buyer to the confidential asset data management system 108 to retrieve additional information about the asset 112 that is stored in the confidential asset data management system 108.

In some embodiments, such additional information is part of the confidential asset data 132 (FIG. 1). As described herein, the confidential asset data management system 108 can store the confidential asset data 132. In some embodiments, the confidential asset data 132 include the encrypted data transmitted from the seller user computing device 104. As described herein, the encrypted data can include the seller's answers to the questionnaire for due diligence, which are encrypted for maintaining confidentiality of the answers. Therefore, the confidential asset data request processing engine 338 operates to direct the buyer to interact with the confidential asset data management system 108 to retrieve the confidential asset data 132 (e.g., the encrypted data of seller's answers) associated with the asset 112.

FIG. 12 is a flowchart of an example method 510 for facilitate a deal between the seller and the buyer regarding the asset 112. As described herein, in some embodiments, the method 510 can be performed by either or both of the deal intent processing engine 340 and the user notification engine 342 (FIG. 4) of the online deal making platform 102. Other computing devices can perform the method 510 in other embodiments.

At operation 512, the deal intent processing engine 340 operates to receive an intent to enter into a deal for the asset 112 from the buyer. In some embodiments, a user interface is provided, which is selectable by the buyer using the buyer computing device 106 to receive the buyer's intent to enter into an agreement with the seller. As discussed herein, in some embodiments, such an agreement can be a non-binding agreement. An example of the user interface is illustrated in FIG. 23.

At operation 514, the user notification engine 342 operates to notify the seller of the buyer's intent. In some embodiments, the user notification engine 342 generates a notification and present to the seller using the seller user computing device 104. The notification can be of various forms, such as a push notification, an email, a text message, or a voice message.

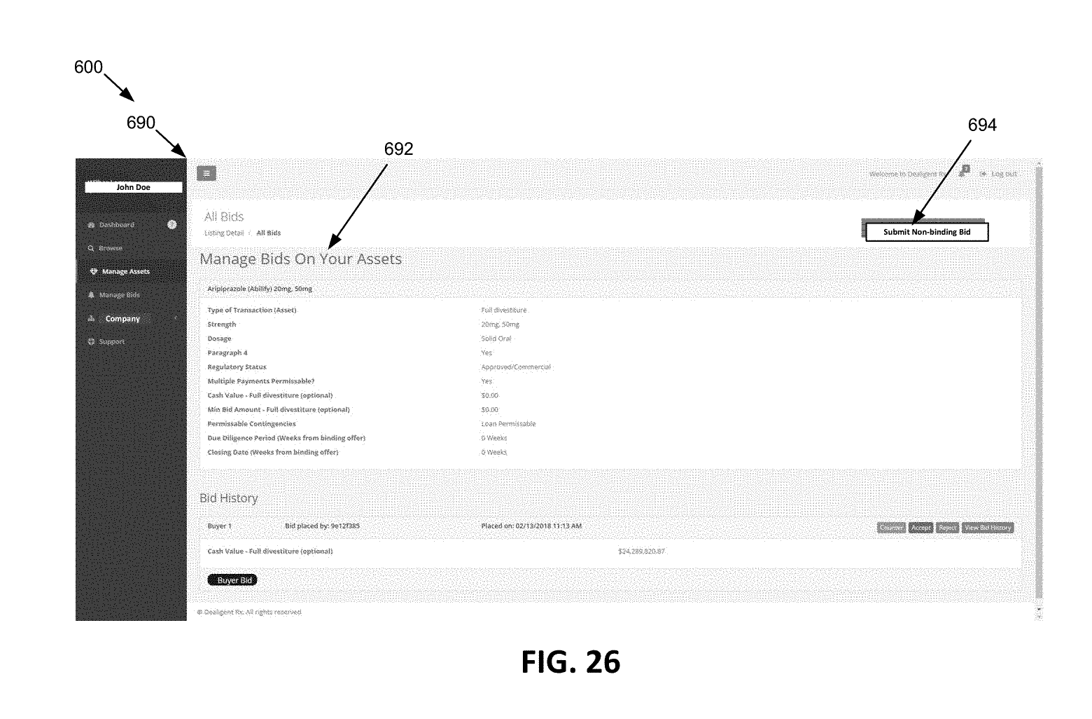

At operation 516, the deal intent processing engine 340 operates to receive an intent from the seller to enter into the deal with the buyer. In some embodiments, a user interface is provided, which is selectable by the seller using the seller user computing device 104 to receive the seller's intent to enter into the agreement with the buyer. An example of the user interface is illustrated in FIG. 26 (a control element 694).

At operation 518, the user notification engine 342 operates to notify the buyer of the seller's intent. In some embodiments, the user notification engine 342 generates a notification and present to the buyer using the buyer user computing device 106. Similarly to the operation 514, the notification can be of various forms, such as a push notification, an email, a text message, or a voice message.

As discussed herein, in some embodiments the online deal making platform maintains the identities of the users, and the companies that they represent, anonymous throughout at least a portion of the process. In some embodiments, once the seller has indicated an intent to enter into the deal from the seller user, the notification in operation 518 further notifies each party of the identities of the other party. This may include the name of the company, the name of a person who should be a point of contact for the transaction, a telephone number, an address, an e-mail address, or other identification and contact information. In other possible embodiments the identities are made available throughout the process and are not anonymous.

Referring to FIGS. 13-26, example layouts of a user interface 600 of the online deal making platform 102. In some embodiments, as described herein, the user interface 600 is implemented with a Web interface (e.g., the Web interface 122, 124) using a Web browser running on a computing device (e.g., the seller user computing device 104 and the buyer user computing device 106).

FIG. 13 illustrates an example layout of a user registration page 602 of the user interface 600. The user registration page 602 is configured to enable a new user to register in the online deal making platform 102 by providing various information, such as personal information, company information, and selection of account level.

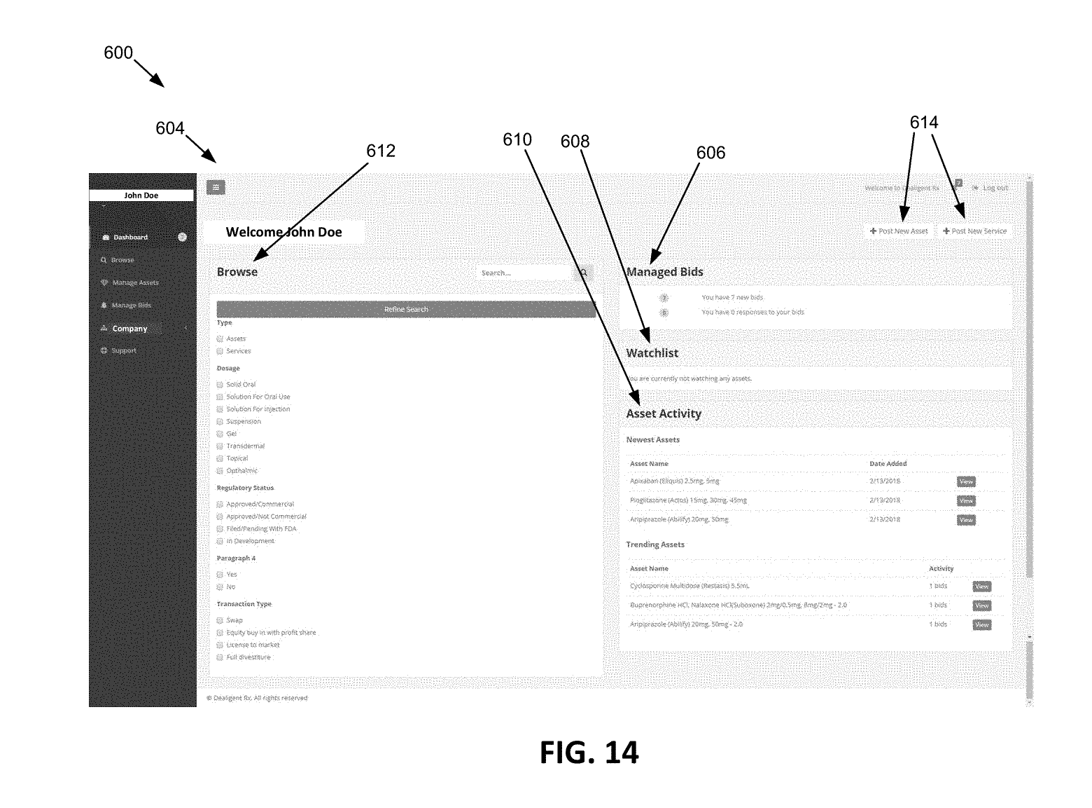

FIG. 14 illustrates an example layout of a dashboard page 604 of the user interface 600. The dashboard page 604 is configured to show the status of activities of a user (e.g., the seller or the buyer), such as the user's biding activities as a buyer (“Managed Bids” 606) and a list of assets that the user monitors (“Watchlist” 608). Further, the dashboard page 604 can show the statuses of various assets (“Asset Activity” 610) provided in the online deal making platform 102 in general. The dashboard page 604 also provides a browse function (“Browse” 612) to search for assets by different search criteria.

In addition, the dashboard page 604 provides a control element 614 that is selectable to enable the user to post a new asset 112 as a seller. When the control element 614 is selected by the user, the prepackaged due diligence application 334 can be executed to perform prepackaged due diligence by asking the seller to answer a standardized questionnaire about the asset 112 to be posted.

Referring to FIG. 15-21, examples layouts of a prepackaged due diligence page 616 are illustrated. As described herein, the prepackaged due diligence page 616 presents a standardized questionnaire 617. The questionnaire 617 can be categorized into a plurality of sections. In the illustrated example, the questionnaire 617 can be grouped into a basic information section 618, a transaction summary section 620, an active pharmaceutical ingredient (API) section 622, an abbreviated new drug application (ANDA) section 624, and a litigation section 626. Various categorizations can be possible depending on the type of assets to be listed.

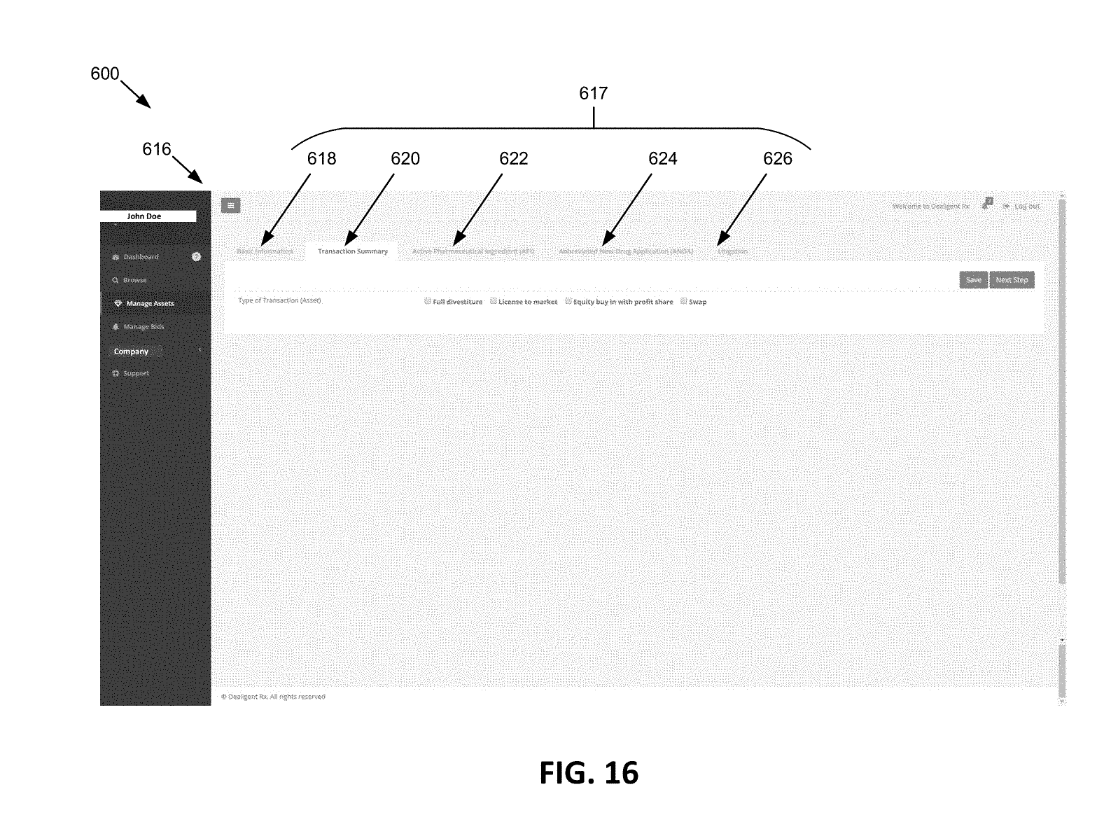

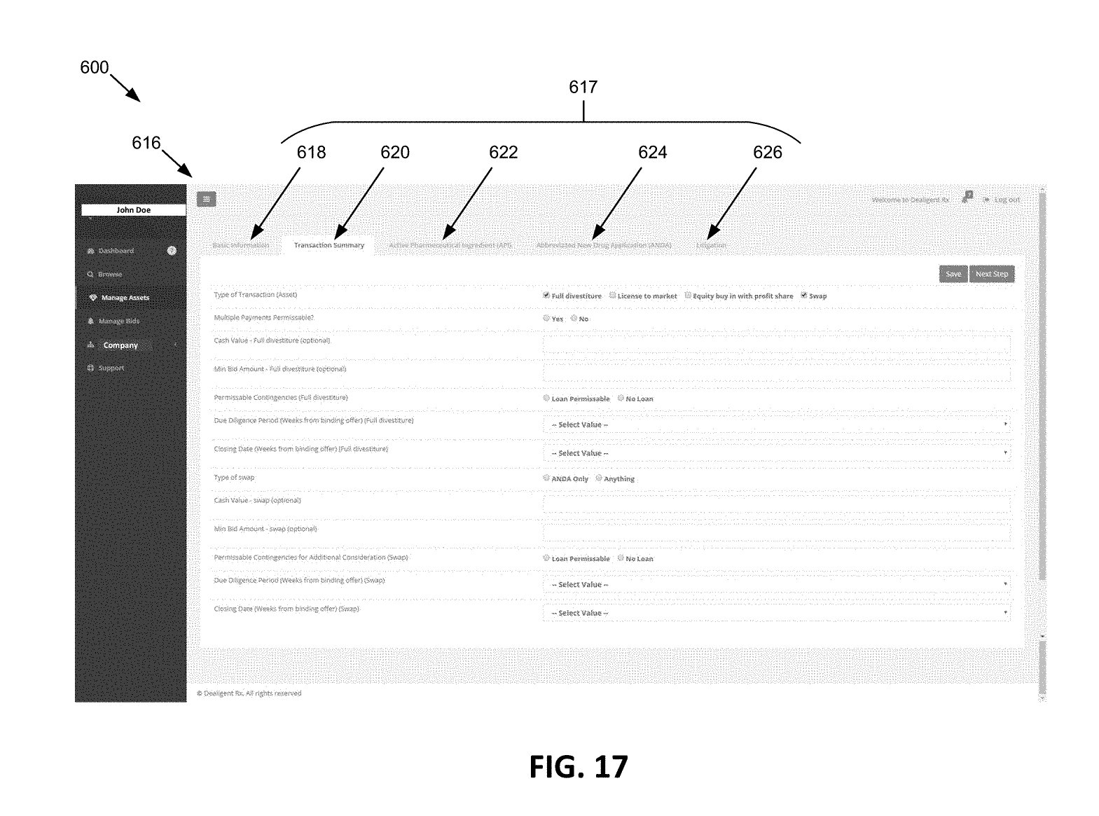

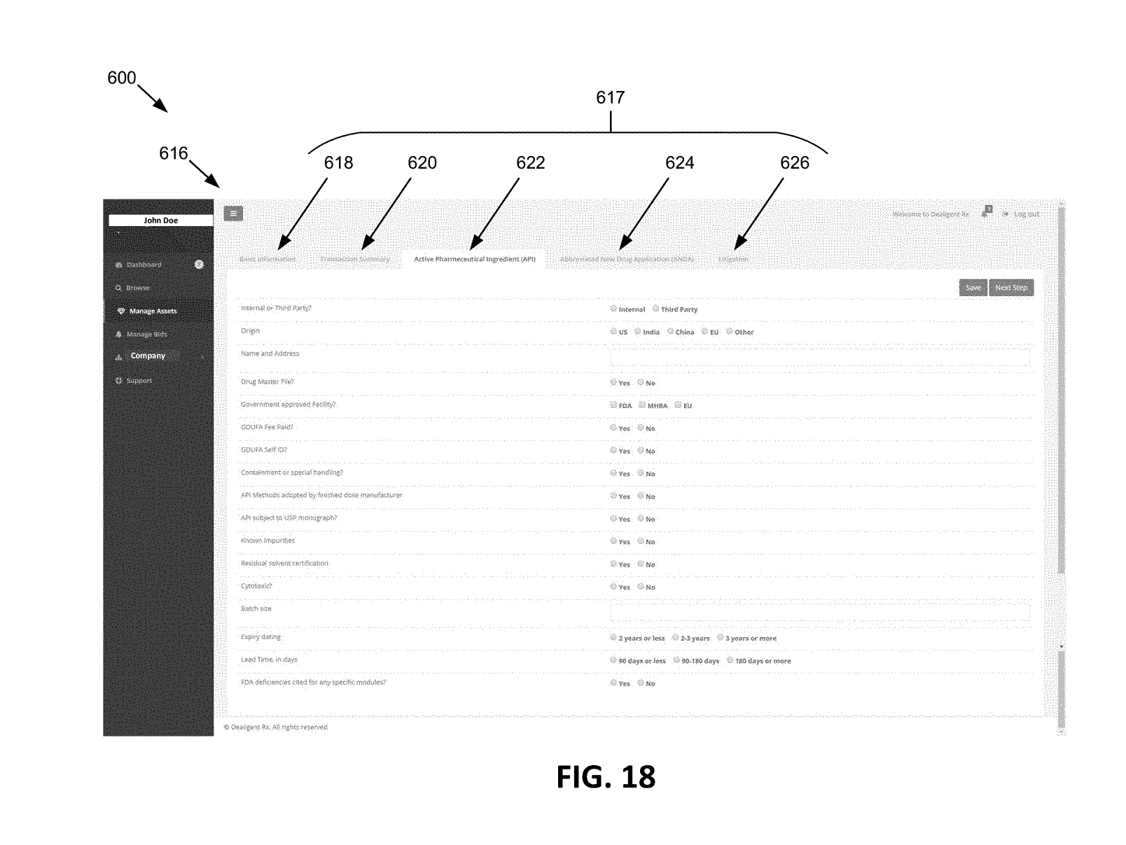

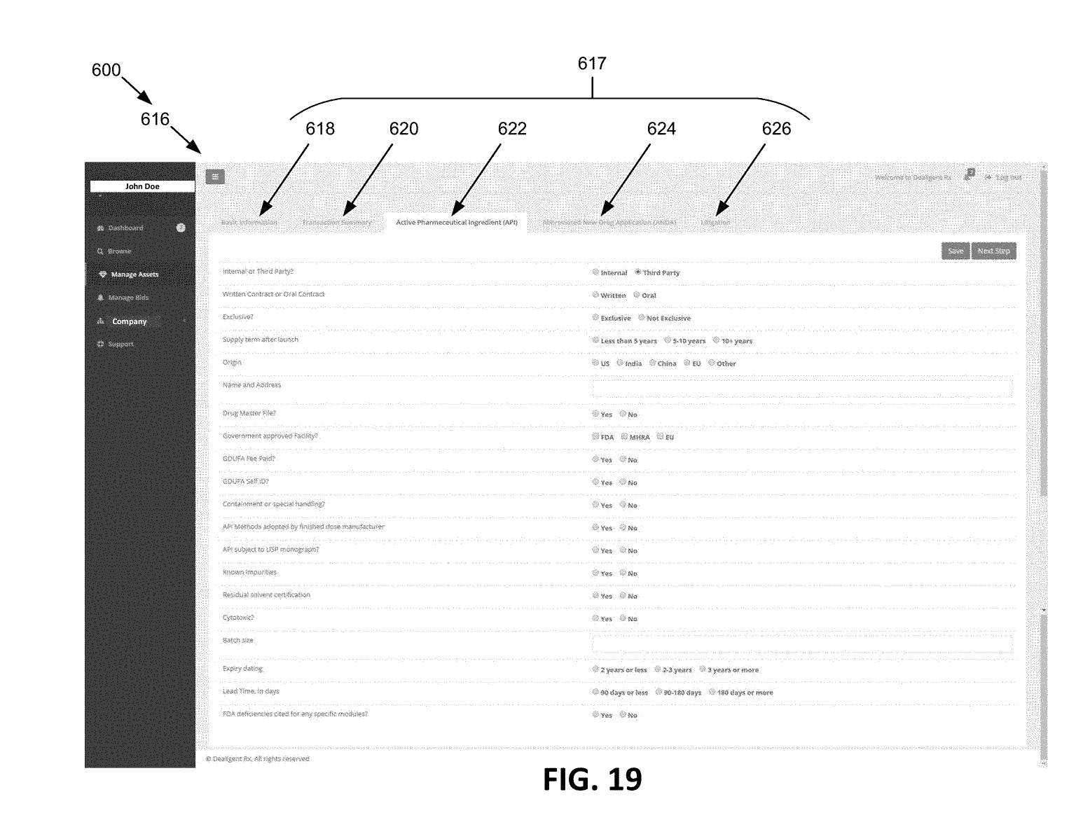

As illustrated in FIGS. 16-19, the questions can be modified according to an answer to a particular question. By way of example, once the user selects one of the types of transition (e.g., “Full divestiture,” “License to market,” “Equity buy in with profit share,” and “Swap”) in FIG. 16, the questions are presented according to the selection, as illustrated in FIG. 17. By way of another example, depending on a user selection between “Internal” and “Third Party” in the API section 622 as illustrated in FIG. 18, the questions are presented according to the selection as illustrated in FIG. 19.

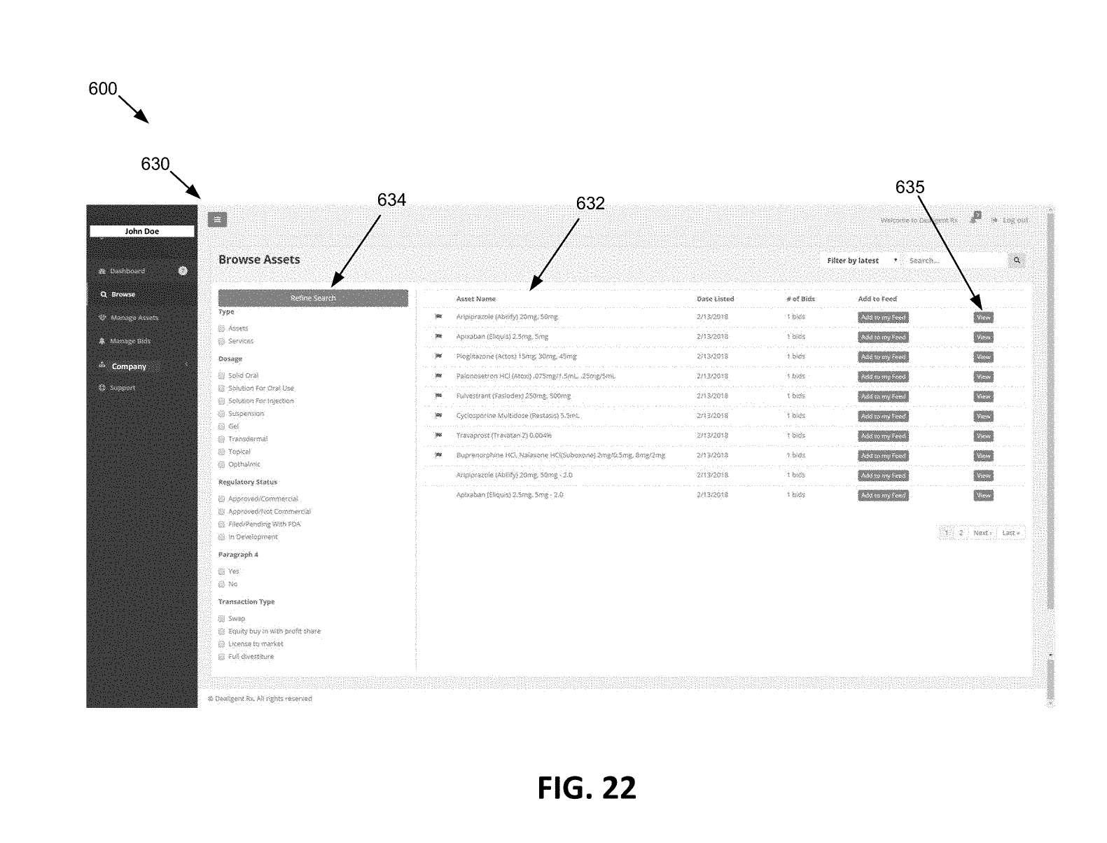

FIG. 22 illustrates an example layout of a browse asset page 630 of the user interface 600. The browse asset page 630 is configured to display a list of assets 632 that available for a bid. The browse asset page 630 further provides a search function 634 that allows the user (as a buyer) to search for assets by different search criteria.

The browse asset page 630 further provides a control element 635 that is selectable to view the details of the asset. Once the control element 635 is selected for a particular asset, the asset listing 120 of that asset is presented, as illustrated in FIG. 23.

FIG. 23 illustrates an example layout of an asset listing page 640 of the user interface 600. The asset listing page 640 is configured to show the asset listing 120 of the asset 112. As described herein, the asset listing 120 includes, or is generated based on, the asset summary 392 that includes the asset scores 402 and the non-confidential description 404 of the asset 112. The asset listing page 640 includes a rating section 642 to present the asset scores 402. The asset listing page 640 further includes an asset description section 644 to present information including the non-confidential information about the asset 112.

In some embodiments, the asset listing page 640 includes a landscape analysis section 646 that presents an analysis of the asset 112. The analysis can be performed by analyzing data about the asset 112 that include the seller's answers to the questionnaire and/or other available information about the asset 112. In some embodiments, the landscape analysis can be performed by a third party, and displayed in the landscape analysis section 646 with or without additional evaluation or modification by the online deal making platform 102.

The asset listing page 640 further includes a selectable control element 648 that is configured to request additional information of the asset 112. An example method for requesting additional information about the asset 112 is described with reference to FIG. 11.

The asset listing page 640 also includes a selectable control element 650 that is configured to receive an intent to enter into a deal. An example method for receiving an intent to enter into a deal is described with reference to FIG. 12.

In another possible embodiment, the example layout of the browse asset page 630 shown in FIG. 23 includes another selectable control element (not shown in FIG. 23) in addition to the elements 648 and 650, such as to request direct contact with the seller. This option can allow the buyer and seller to interact directly with each other to exchange information about the asset and/or to directly negotiate regarding the asset 112 separate from the system 100. In some embodiments, selection of this selectable control provides direct contact information to the buyer. In other embodiments, the buyer can enter a message that is then sent to the seller through the system 100. The buyers message can include the buyers direct contact information, and an invitation for the seller to directly contact the buyer using the direct contact information. In yet another embodiment, a message is sent to the seller through the system 100 requesting permission to provide the seller's direct contact information to the buyer, and if approved by the seller, then the seller's direct contact information is provided to the buyer. Even if direct contact is chosen, the parties may still choose to resume use of the system 100 at any point in the process, and can still utilize the system thereafter, such as to view information in the data room, or to submit a bid.

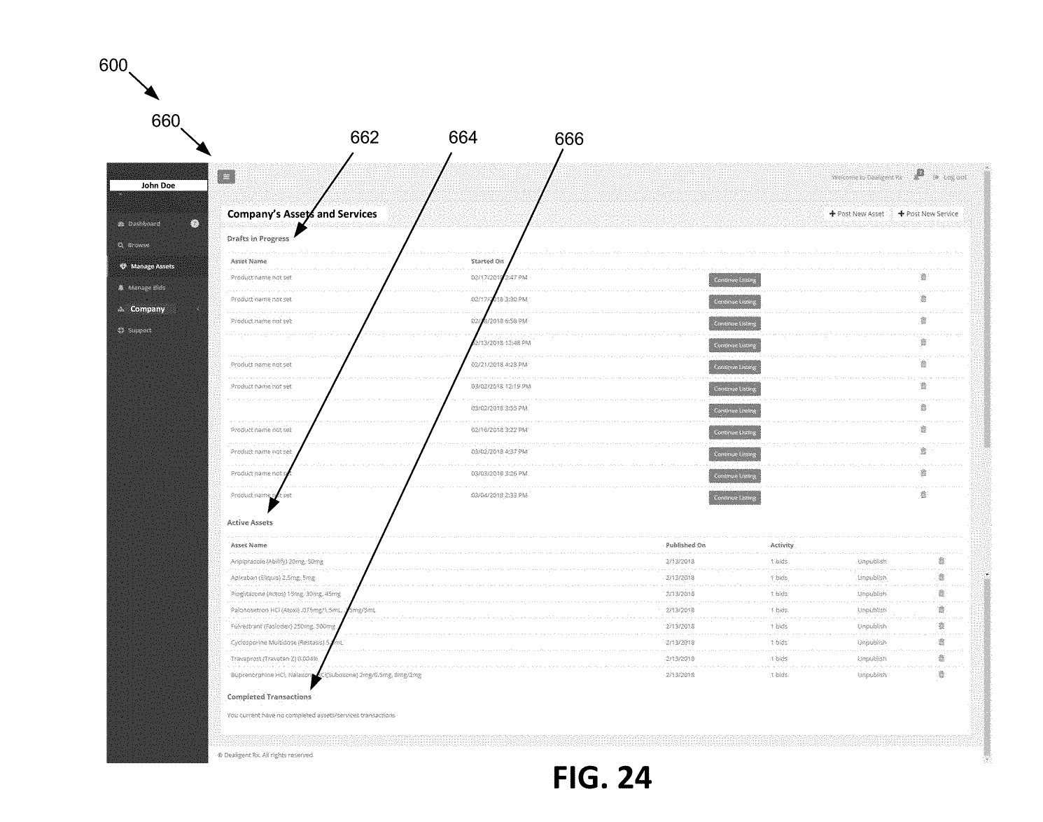

FIG. 24 illustrates an example layout of a seller asset management page 660 of the user interface 600. The seller asset management page 660 is configured to show a list 662 of drafts for posting new assets that are in progress, a list 664 of active assets subject to potential or existing bidding, and a list 666 of completed transactions. The seller can select one of the drafts in the list 662 and answer unanswered questions in the questionnaire to complete the due diligence and post the asset 112 in the online deal making platform 102.

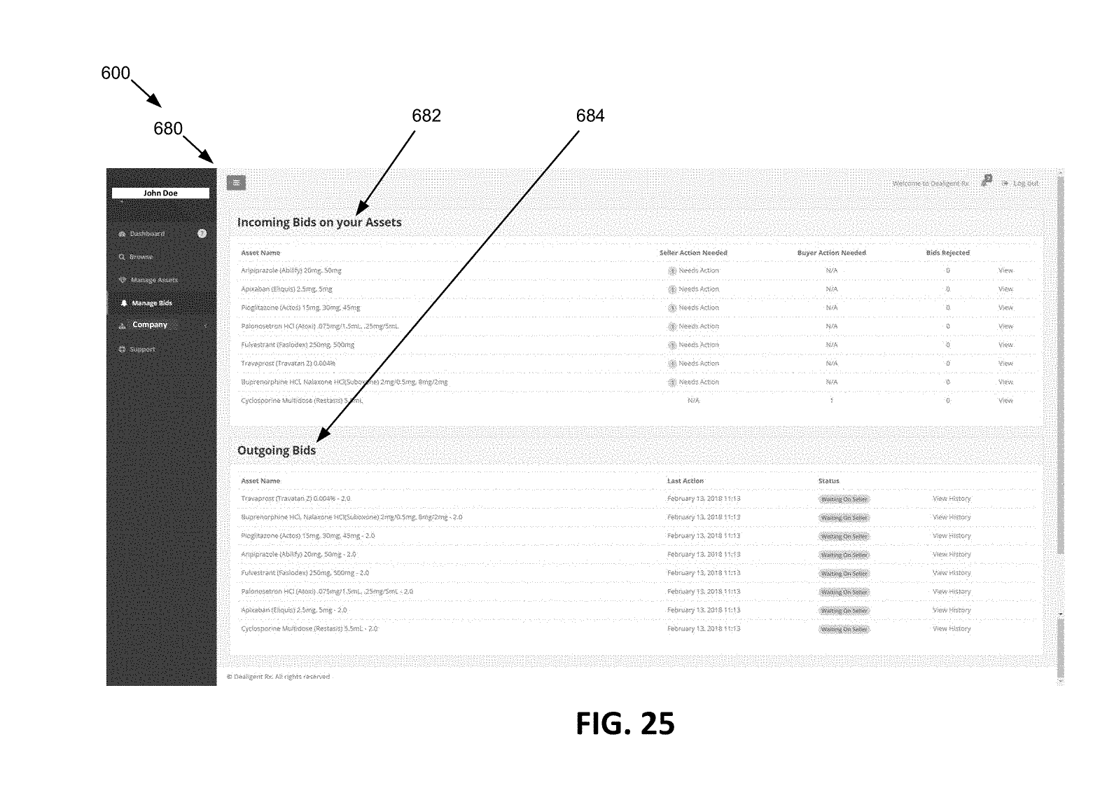

FIG. 25 illustrates an example layout of a bid management page 680 of the user interface 600. The bid management page 680 is configured to show a list 682 of incoming bids on the assets posted by the user as a seller, and a list 684 of outgoing bids made by the user as a buyer.

FIG. 26 illustrates an example layout of an incoming bid management page 690 of the user interface 600. The incoming bid management page 690 is configured to show details 692 of one or more incoming bids on seller's particular asset(s), and allow the seller to manage the bids.

The present disclosure describes an online deal making platform for asset transactions. The assets that are the subject of the transaction can be a wide variety of possible assets. Some specific examples are discussed herein. The assets can include just goods, just services, or goods and services. In some embodiments an asset is at least one of a good and a service. Several examples of goods include raw materials, basic resources, agricultural products, generic and branded pharmaceuticals, and other commodities. Assets can also include a wide variety of other goods not specifically listed here. Several examples of services include financial services (such as loan services, such as a FinTech loan application site, for example), employment services (such as recruiting or online employment services), legal services, company sales services, facility or real estate sales services, transaction services, and the like. Services can also include a wide variety of other services not specifically listed here.

The various examples and teachings described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

What is claimed is:

1. An online deal making platform for facilitating transactions between parties, the platform comprising:
at least one processing device; and
at least one computer readable storage device storing instructions that, when executed by the at least one processing device, cause the at least one processing device to:
transmit data instructions to a seller user's computing device, the data instructions being executable by the seller user's computing device to generate prepackaged due diligence for an asset, the data instructions being executable to:
prompt the user to answer questions about the asset; and
receive answers to the questions, the answers including confidential information; and
process the answers to generate a summary of the asset including at least one asset score, wherein the at least one asset score is based at least in part on the confidential information but does not contain the confidential information;
transmit the summary of the asset to the online deal making platform;
store the answers to the questions for transmission to a data room without transmitting the answers to the online deal making platform;
generate an asset listing including the summary of the asset;
present the asset listing to a buyer user;
receive a request from the buyer user to obtain additional information about the asset;
direct the buyer user to the data room to obtain additional information about the asset;
receive an intent to enter into a deal for the asset from a buyer user; and
notify the seller user of the buyer's intent to enter into a deal for the asset.

2. The online deal making platform of claim 1, wherein the asset includes at least one of a good and a service.

3. An online deal making platform for transactions, the system comprising:
at least one processing device; and
at least one computer readable storage device storing instructions that, when executed by the at least one processing device, cause the at least one processing device to:
receive descriptions of assets from seller users of the online marketplace;
evaluate the assets based on the descriptions;
generate a plurality of listings associated with the assets, each of the listings including the evaluation of a corresponding asset;
present the plurality of listings to buyer users;
receive a request for a transaction of at least one of the plurality of listings from at least one of the buyer users; and
notify at least one of the seller users associated with the at least one of the plurality of listings that the request of a transaction is received from the at least one of the buyer users.

4. The online marketplace system of claim 3, wherein the online marketplace is further configured to:
receive a user input of accepting the request for the transaction from the at least one of the seller users; and
notify the at least one of the buyer users that the request is accepted.

5. The online marketplace system of claim 3, wherein the descriptions including confidential information and non-confidential information, and wherein each of the listings including the non-confidential information of the description of the corresponding asset.

6. The online marketplace system of claim 5, wherein the online marketplace is configured to receive descriptions of assets by:
receiving asset listing requests from the seller users;
presenting questionnaires to the seller users; and
receiving answers to the questionnaires from the seller users, the answers including the confidential information and the non-confidential information.

7. The online marketplace system of claim 5, wherein the online marketplace is further configured to:
encrypt the confidential information of the descriptions of assets; and
transmit the encrypted confidential information to a database.

8. The online marketplace system of claim 7, wherein the online marketplace is further configured to:
receive a request for further investigation associated with at least one of the plurality of listings from at least one of the buyer users;
enable the at least one of the buyer users to interact with a database access system to access the confidential information stored in the database.

9. The online marketplace system of claim 7, wherein the database access system is operated separately from the online marketplace.

10. The online marketplace system of claim 1, wherein the online marketplace is configured to evaluate the assets by:
evaluating legal statuses of the assets;
evaluating regulatory statuses of the assets; and
evaluating marketability of the assets.

11. The online marketplace system of claim 3, wherein the online marketplace is configured to evaluate the assets by:
generating ratings of the assets.

12. The online marketplace system of claim 3, wherein the assets includes goods or services that require at least one regulatory approval.

13. A method for facilitating transactions, the method comprising:
transmit data instructions to a seller user's computing device, the data instructions being executable by the seller user's computing device to generate prepackaged due diligence for an asset, the data instructions being executable to:
prompt the user to answer questions about the asset;
receive answers to the questions, the answers including confidential information; and
process the answers to generate a summary of the asset including at least one asset score, wherein the at least one asset score is based at least in part on the confidential information but does not contain the confidential information;
transmit the summary of the asset to the online deal making platform; and
store the answers to the questions for transmission to a data room without transmitting the answers to the online deal making platform;
generate an asset listing including the summary of the asset;
present the asset listing to a buyer user;
receive a request from the buyer user to obtain additional information about the asset;
direct the buyer user to the data room to obtain additional information about the asset;
receive an intent to enter into a deal for the asset from a buyer user; and
notify the seller user of the buyer's intent to enter into a deal for the asset.

14. A database server for managing confidential asset data for online transactions, the database server comprising:
at least one processing device; and
at least one computer readable storage device storing instructions that, when executed by the at least one processing device, cause the at least one processing device to generate an online marketplace to:
receive encrypted data of confidential information from seller computing devices, the confidential information including at least one seller's answer to a due diligence questionnaire about an asset;
store the encrypted data;
receive a request for additional information about the asset from a user computing device; and
transmit at least part of the encrypted data to the user computing device.

15. An online platform for facilitating transactions between parties, the platform comprising:
at least one processing device; and
at least one computer readable storage device storing instructions that, when executed by the at least one processing device, cause the at least one processing device to:
transmit data instructions to a seller user's computing device, the data instructions being executable by the seller user's computing device to generate prepackaged due diligence for an asset, the data instructions being executable to:
prompt the user to answer questions about the asset; and
receive answers to the questions, the answers including confidential information;
process the answers to generate a summary of the asset including at least one asset score, wherein the at least one asset score is based at least in part on the confidential information but does not contain the confidential information;
transmit the summary of the asset to the online platform;
store the answers to the questions for transmission to a data room without transmitting the answers to the online platform;
generate an asset listing including the summary of the asset;
present the asset listing to a buyer user; and
direct the buyer user to the data room to obtain additional information about the asset.
